(19) United States
(12) Patent Application Publication
(10) Pub. No.: US 2019/0088149 A1
(43) Pub. Date: Mar. 21, 2019

(54) VERIFYING VIEWING OF CONTENT BY USER

(71) Applicant: Money Media Inc., New York, NY (US)

(72) Inventors: Daniel I. Fink, Plainview, NY (US); Shera Ahmad, Hastings on Hudson, NY (US); Benjamin C. Northover, Brooklyn, NY (US); Christopher B. Pini, West Caldwell, NJ (US)

(21) Appl. No.: 15/708,797

(22) Filed: Sep. 19, 2017

(51) Int. Cl. G09B 5/02; G06F 3/0483; G09B 5/06

(52) U.S. Cl. CPC G09B 5/02; G06F 3/04842; G09B 5/065; G06F 3/0483

(57) ABSTRACT

A viewing verification application hosted on a viewing authentication apparatus is configured to verify whether a user has viewed content for a predetermined period of time in order to receive continuing education (CE) credit. The application includes a content display module to display a document selected by a user. The document includes a plurality of pages. The application also includes a timer generating module to generate a document viewing period and a plurality of page viewing periods corresponding to respective ones of the plurality of pages of the document. The timer generating module also generates a document viewing timer and a plurality of page viewing timers for respective ones of the pages. When the content display module displays a first page of the plurality of pages to the user, the timer generating module starts a first timer. The timer generating module also starts the document viewing timer. The content display module allows the user to view a subsequent page only after the first timer measures a time greater than or equal to the page viewing period corresponding to the first page. The user is allowed to view each subsequent page only after viewing the current page for its respective page viewing period. When the user reaches the final page and has viewed the document for the document viewing period as measured by the document viewing timer, the user is awarded CE credit.

### TECHNICAL FIELD

This disclosure relates to systems, apparatuses, applications, methodologies and other tools to verify that users have viewed content for a predetermined period of time, and more specifically, such tools including one or more timers to perform the verification.

### BACKGROUND

In many areas of professional employment, it vital to be up-to-date on the most recent changes to and developments in the field of employment. In fact, many professional certifying organizations or bodies encourage (or even require) their members to earn education credits to verify that they are familiar with the latest developments.

Many certifying bodies or organizations offer classes, or accredit the content of classes offered by third party organizations, to assist these individuals in earning such education credits. For example, classes may be live events conducted at a designated location, or on-line webinars presented at a designated time. Further, in order to receive credits, the certifying bodies may establish requirements for the individuals' attendance and/or participation in the classes, to ensure a threshold degree of exposure to the accredited content, which the certifying bodies assume would be sufficient to ensure comprehension of the accredited subject matter.

However, classes are often expensive and are offered at select times and/or locations which may be difficult (or inconvenient) for individuals to reach, or which may interfere with the work hours dictated by the individuals' employment. Thus, it may be more efficient to allow individuals to earn credits in a more flexible (and inexpensive) manner with regard to their location and schedule. One possible solution would be to provide learning material in an electronic format that can be accessible by electronic devices such as a computer or a smartphone. Thus, individuals may have the means to view the learning material at the location and time of their choice.

However, if individuals view the learning material on their own time by electronic means, they would need a way to demonstrate that their viewing of the learning material was sufficient to comprehend the substantive content, or meet the applicable attendance and participation requirements established by the certifying bodies, for earning the credits associated with the learning material.

One method for demonstrating comprehension based on viewing learning material in electronic format is to provide a quiz on the accredited content. If the user scores higher than a predetermined amount on the quiz, he or she may obtain approval for the credits associated with the learning material. On the other hand, in the case that the individual doesn't achieve such a high score, he or she does not obtain any credit. However, a quiz is an inefficient means to demonstrate comprehension of the learning material.

For example, a quiz adds extra development and cost factors, as a person (or organization) must develop questions for the quiz which focus on the accredited content, and a graphical user interface (GUI) for administering the quiz to the users. Quizzes also create an additional time burden on the users. In some circumstances quizzes may not be a viable solution.

Thus, there remains a need for users of computers and other information terminals (personal computers, notebook computers, workstations, other types of computers, kiosks, PDAs, other information appliances, etc.) to demonstrate that they have viewed electronic format learning material in a manner that complies with the requirements of a certifying body, based on attendance and/or participation factors similar to those used by certifying bodies in a live or Internet-based classroom format.

Also, some certifying bodies have accredited content contained in long-form written articles and research papers, and have established rules which allow individuals to earn credits by viewing these types of learning materials provided the learning materials contain a minimum word count (e.g., 9,000 words). In recent times, there has been developing a large body of shorter-form articles which contain accredited content, for example, news articles, white papers, and the like. However, individuals cannot earn credit for viewing short-form materials that do not contain a designated minimum word count.

Accordingly, there is a need for a viewing verification system which allows users to view multiple learning materials and aggrege attendance and/or participation data to demonstrate compliance with certification requirements.

### SUMMARY

Various tools (for example, a system, an apparatus, host terminal for a mobile application; application software, a method, etc.) can be provided to determine whether users have viewed content for a predetermined period of time.

According to an embodiment of the disclosure, a viewing verification application dynamically converts pages of a document from a first format, such as .pdf, into an .html format which displays pages of the document in a manner that looks like the original .pdf document pages. The application collects timing statistics associated with viewer behavior based on a set of predetermined rules, and uses the timing statistics to allow users to demonstrate qualification for accreditation and receive accreditation credits based on the content displayed on the pages.

According to another embodiment a viewing verification application is provided that includes one or more programs of instructions embodied in a non-transitory computer readable medium and executable by a computer to configure the computer to comprise a content display module to display a document selected by a user, the document comprising a plurality of pages, and a timer generating module to generate a document viewing period and a plurality of page viewing periods corresponding to respective ones of the plurality of pages and for generating a document viewing timer and a plurality of page viewing timers for respective ones of the pages, wherein the content display module displays a first page of the plurality of pages to the user and starts a first timer, and wherein the content display module allows the user to view a subsequent page after the first timer measures a time greater than or equal to the page viewing period corresponding to the first page.

According to one aspect, the document viewing period is generated based on a word count of the document and/or the plurality of page viewing periods are generated based on a word count of the respective pages. According to another aspect, the document includes one or more non-text portions, and the document viewing period and/or one or more of the page viewing periods are generated based on a length of time to present such non-text portions. The non-text portion may comprise a video clip.

According to a further aspect of the disclosure one or more subsequent viewing timers are started when the user selects to view one or more respective subsequent pages of the plurality of pages, wherein the user is allowed to view such subsequent pages when the viewing timer of a previous page measure times greater than or equal to the viewing period corresponding to a previous page.

The application may further comprise a credit approval module for generating an education credit in a case that the user has viewed each of the plurality of pages and the total document viewing time is greater than or equal to the document viewing period.

According to a further aspect the application may further comprise a content publishing module that receives the document and converts the document to a predetermined file format.

According to another embodiment of the disclosure, there is provided a method for confirming that a user is entitled to an education credit comprising the steps of i) receiving an authenticated content document, the document comprising a plurality of pages, ii) establishing for the document a required document viewing period, iii) establishing a plurality of required page viewing periods for respective ones of the plurality of pages, iv) transmitting the authenticated content document to a user via a computer network, v) receiving user viewing data, the viewing data indicating operations conducted by the user in regard to the authenticated content document, vi) monitoring viewing activity of the user, and vii) recording an indicia that the user has received the education credit. The step of monitoring may comprise a) detecting, from the viewing data, that the user has opened the document for viewing, b) starting a document timer for recording a document viewing time, c) detecting, from the viewing data, that the user has opened for viewing a first one of the plurality of pages of the document, d) starting a first page timer to record a viewing time for the first page, e) detecting, from the viewing data and the first page timer, that the user has viewed the first page for the required page viewing period for the first page, f) detecting, from the viewing data, that the user has opened a next page of the plurality of pages of the document for viewing, g) starting a next page timer to record a viewing time for the next page, h) detecting, from the viewing data and the next page timer, that the user has viewed the next page for the minimum required page viewing time for the next page, i) repeating steps f) through h) until all of the plurality of pages have been opened for viewing and j) determining, based on the document timer and the viewing data, that document viewing time is greater than or equal to the required document viewing period. and

According to an aspect of the disclosure the required document viewing period or the required page viewing periods are established based on a word count at an assumed reading pace. That pace may be 150 words per minute.

According to another aspect, the method further comprises establishing a maximum credit period for the document, wherein the step of record further comprises recording as part of the indicia the document viewing time or the maximum credit period, whichever is greater.

### BRIEF DESCRIPTION OF THE DRAWINGS

The aforementioned and other aspects, features and advantages can be more readily understood from the following detailed description with reference to the accompanying drawings wherein:

FIG. 1A shows a block diagram of a system that can include various provisions to verify viewing of content by a user, according to an embodiment of this disclosure;

FIG. 1B shows a block diagram of a system for verifying viewing of content by a user, according to another embodiment;

FIG. 1C shows a block diagram of a system for verifying viewing of content by a user, according to another embodiment;

FIG. 1D shows a block diagram of a system for verifying viewing of content by a user, according to another embodiment;

FIGS. 2A and 2B show an example by way of tables to indicate how different users may obtain credit based on the amount of time each spends on viewing content, according to an exemplary embodiment;

FIG. 3 shows a block diagram of a configuration of a viewing authentication apparatus (e.g., FIG. 1A, 1B, 1C, or 1D), a metrics management apparatus (e.g., FIG. 1B), and a certification management apparatus (e.g., FIG. 1D);

FIG. 4 shows a block diagram of an exemplary configuration of a terminal, such as illustrated in FIG. 1A, 1B, 1C, or 1D, according to an embodiment;

FIG. 5 shows a flow diagram in which a creator can create one or more document for publishing, according to an embodiment

FIGS. 6A-6E show examples of user interface screens for a creator in connection with a viewing verification application, according to an embodiment;

FIG. 7 shows a flow diagram in which the user can register for an account to view content or acquire education credit, according to an embodiment;

FIGS. 8A-8D show examples of user interface screens for a user in connection with a viewing verification application, according to an embodiment;

FIG. 9 shows a flow diagram in which a viewing verification application determines how to rank order a list of documents, according to an embodiment;

FIGS. 10A and 10B show examples of user interface screens for a user in connection with a viewing verification application, according to an embodiment;

FIG. 11 show a flow diagram in which the viewing verification application receives and processes a new document, according to an embodiment;

FIGS. 12A and 12B show a flow diagram in which the viewing verification application provides content to the user, according to an embodiment;

FIGS. 13A-13J show examples of user interface screens for a user in connection with a viewing verification application, according to an embodiment;

FIG. 14 shows a flow diagram in which a viewing verification application detects whether the user is viewing the document, according to an embodiment.

### DETAILED DESCRIPTION OF EMBODIMENTS

In describing preferred embodiments illustrated in the drawings, specific terminology is employed herein for the sake of clarity. However, this disclosure is not intended to be limited to the specific terminology so selected and it is to be understood that each specific element includes all technical equivalents that operate in a similar manner. In addition, a detailed description of known functions and configurations is omitted from this specification when it may obscure the inventive aspects described herein.

Various tools to facilitate verification that a user has genuinely viewed content are discussed herein. It should be appreciated by those skilled in the art that any one or more of such tools may be embedded in the application and/or in any of various other ways, and thus while various examples are discussed herein, the inventive aspects of this disclosure are not limited to such examples described herein.

The present disclosure relates to a system for displaying documents that provides educational content to users. Documents are displayed to the user on a page-by-page basis. The system monitors the amount of time the user spends viewing each page of a document and assumes that the reader has spent sufficient time viewing each page to understand the contents, based on an assumed time frame corresponding to a typical reader. The user is prevented from moving to the next page until he or she has spent sufficient time on a current page.

When the viewer reaches the final page of the document, the system compares the overall time the user has spent viewing the entire document with a predetermined document viewing period, which is the amount of time a typical user would need to spend reading the document to comprehend the educational information. If the user has spent sufficient time viewing the document, educational credit is recorded on behalf of the user. This educational credit is accumulated by the system until the user accumulates an entire educational unit, for example, a credit hour. Credit hours may be communicated to a certifying body and used to assume that the user has complied with continuing education (“CE”) requirements.

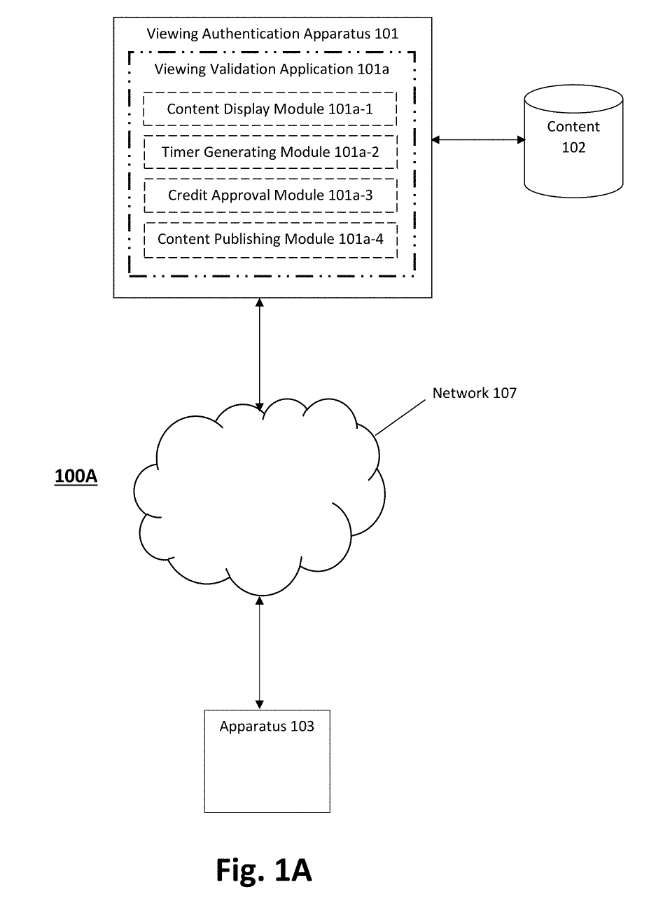

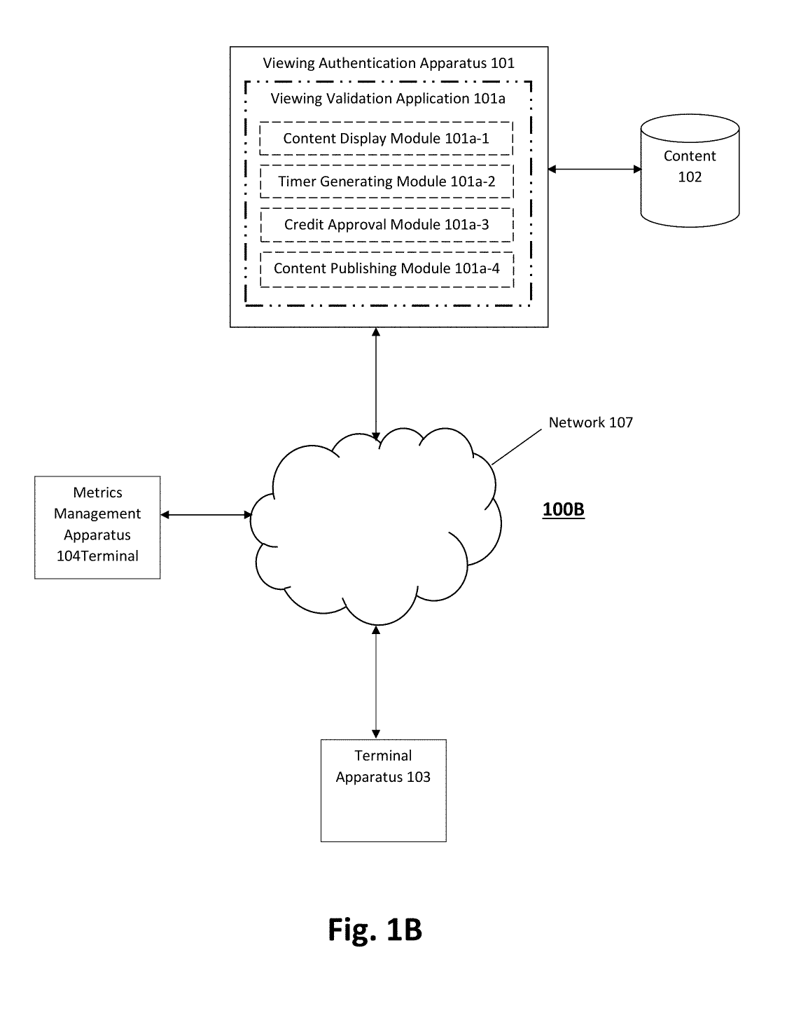

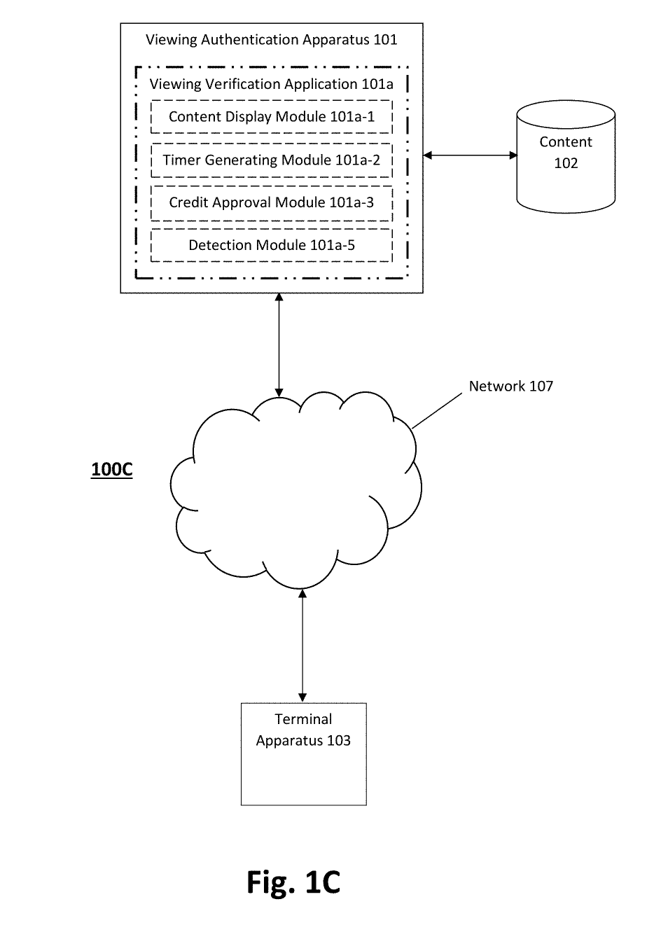

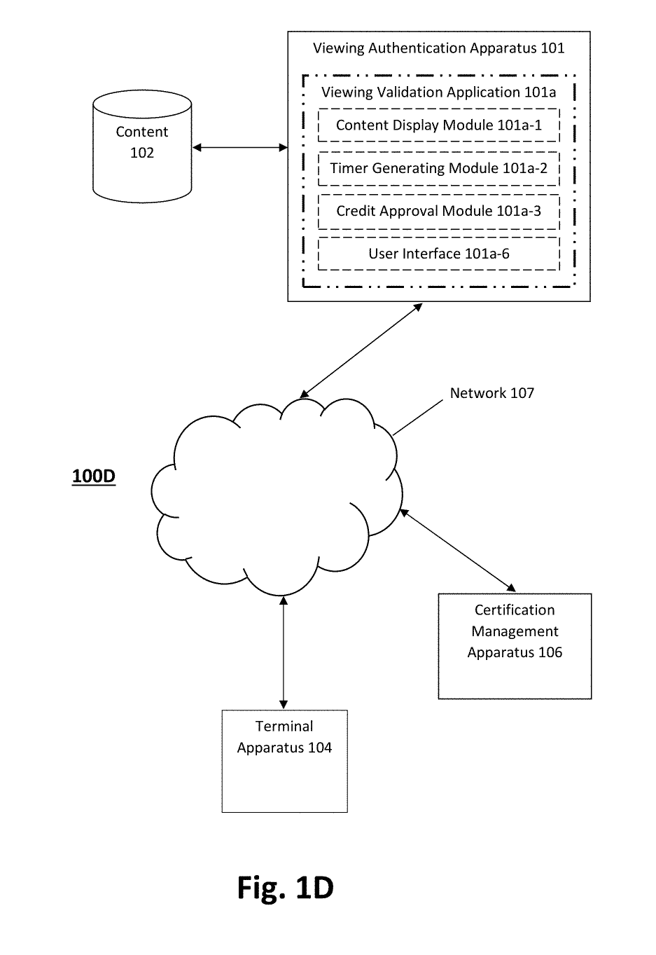

Documents embodying educational information may be created by various authors and submitted to an entity authorized to accredit content and/or administer procedures for earning continuing education credits. Typically, such authors, or organizations employing those authors, submit the document to the authorizing entity. That entity reviews the submitted documents to assure that they meet requirements, such as, for quality, appropriate subject matter, accreditation, and document length. The entity then processes the document, if necessary converting the document into a format suitable to be displayed using the page viewing times and document viewing time periods that will be discussed more fully below. The documents are processed to determine viewing periods associated with the certifying body's requirements, and stored in a database that is accessible to users seeking CE credits. Referring now to the drawings, wherein like reference numerals designate identical or corresponding parts throughout the several views, FIG. 1A shows schematically a system 100A that includes a viewing authentication apparatus 101, a content database 102 and a terminal apparatus 103. Each of the viewing authentication apparatus 101 and the terminal apparatus 103 are configured to connect to a network 107.

The viewing authentication apparatus 101 includes a viewing verification application 101a which in turn comprises a content display module 101a-1, a timer generating module 101a-2, a credit approval module 101a-3, and a content publishing module 101a-4.

The content display module 101a-1 determines how content (e.g., a document with educational content) is to be displayed to a user. As discussed more fully below, this module divides the document into one or more pages (or sections, paragraphs, sentences, words, etc.) and computes an amount of time a viewer needs to view each page to obtain CE credit. In an embodiment, the content display module 101a-1 receives a document in the form of file format that inherently defines pages (e.g., .doc, .pdf, .djvu, etc.). According to this embodiment, the content display module 101a-1 divides the document based on such pages. In another embodiment, content display module 101a-1 divides the document into one or more pages based on attributes of the document (document attributes) which may include word/character length (e.g., 100 words per page, 590 characters per page, etc.), as well as factors that may affect how long a typical viewer would take to read and understand the information, for example but not limited to, language (e.g., French, Chinese, Russian, Arabic, Hindi, etc.), or complexity of the material (e.g., technology, science, terminology, etc.).

In one embodiment, the content display module 101a-1 determines the document attributes based on metadata placed by an author of the document or the organization publishing the document. Such metadata is a description of a file and is located within the file itself. Such metadata could be information relating to, for example but not limited to, the file size, the number of pages, the number of words, images in the file, videos in the file, the time the file was created, the last time the file was updated, the author of the file, or standards used to create the file.

In another embodiment, the content display module 101a-1 performs optical character recognition (OCR) to analyze text or other information that is displayed graphically. An image containing text may be converted via OCR to produce a text captured content page portion. Such process may be performed, for example, via pattern recognition by artificial intelligence. For content documents that include non-machine encoded text (e.g., handwriting), the content display module 101a-1 may extract such text, which can be used when determining the document attributes and/or which can be viewed by a user to obtain CE credits.

In addition, the content display module 101a-1 performs file conversion on the document. When the content display module 101a-1 receives a document in a file format (e.g., .doc, .ppt, .xls, .pdf, .djvu, .mp3, .wmv, etc.) that may be incompatible with other portions of the system, the content display module 101a-1 converts the document into an acceptable file format, which may be specified by an administrator or manager. According to one embodiment, the document is converted to hypertext mark-up language (html). According to a further embodiment, text-to-speech processing is performed on the document. Users are able to listen to the spoken version of the document instead of or in addition to viewing the document in order to obtain CE credit as described below.

The timer generating module 101a-2 determines an amount of time the user must spend reviewing the document in order to be eligible to earn CE credit in connection with the document viewed. To facilitate this, the timer generating module 101a-2 generates a page viewing period for each page of the document and a document viewing period for the document as a whole. In addition, the timer generating module 101a-2 instantiates page timers to keep track of the time spent viewing each page of the document and a document timer to keep track of time spend viewing the document as a whole, as will be discussed below. The timer generating module 101a-2 utilizes the page timers and the document timer to determine whether the user has completed the page viewing periods and the document viewing period, respectively.

The document viewing period is the amount of time that the user must spend viewing the entire document to be eligible for obtaining CE credit. For example, for a particular document, the timer generating module 101a-2 may determine that a user is eligible for credit after viewing a document for a document viewing period of 20 minutes. Provided the user spends at least that amount of time viewing the document, the user receives credit for viewing the document. In one embodiment, the user is not required to view the document for the entire document viewing period. A portion of the document viewing period (which may be specified by an administrator or manager), such as 83%, may be specified in order to qualify for earning CE credit. For example, for a document with a document viewing period of 20 minutes, according to one embodiment, the user only needs to spend 16.6 minutes (i.e. 83% of 20 minutes) viewing the document to be eligible for the credit. According to this embodiment, the amount of CE credit the user receives is equal to the actual time spent reviewing the document, up to a maximum equal to the document viewing period. If the document has been processed using text-to-speech processing, the document viewing period may be set to the length of time required for the spoken text to be played to the user.

In one embodiment, the timer generating module 101a-2 determines the document viewing period based on the number of words in the document. According to one embodiment, a reading pace for a typical user is assumed, for example, to be 150 words per minute. Based on the typical reading pace, and the number of words in the document, a document viewing period is calculated. Thus, a document that is 4,500 words long would have a document viewing period of 30 minutes.

In another embodiment, the document viewing period may be determined by other factors including the complexity of the subject matter of the document. For example, documents including complex subject matter might be given a longer document viewing period. According to one embodiment a document could be scored based on readability statistics such as the Flesch Reading Ease Index. [For documents that are scored higher on such an index, the document viewing period is adjusted to require additional viewing time. In yet another embodiment, the timer generating module 101a-2 obtains the document attributes from the content display module 101a-1. In yet another embodiment, the timer generating module 101a-2 obtains the document attributes from metadata of the document. According to a further embodiment, document viewing time is adjusted based on non-text attributes of a document, such a charts, graphs, tables, diagrams, and the like. For example, a document that includes information displayed graphically may have a longer required document viewing time to allow users to consider information displayed graphically.

The page viewing period determines the minimum amount of time a user must spend viewing each page of the document before being permitted to view the next (i.e. subsequent) page. For example, a page viewing period for a particular page may be specified as 2 minutes based on a typical reading pace and the number of words on the page. The user is permitted to view the next page only after 2 minutes has passed. In another embodiment, the user is not required to view a page for the entire page viewing period to be able to move on to the subsequent page. Instead, a user is able to view the subsequent page if the user views a page for a predetermined portion of the page viewing period (e.g., 50%).

In another embodiment, the timer generating module 101a-2 generates a plurality of page viewing periods (i.e. a different page viewing period for each page). The plurality of page viewing periods corresponds to the one or more pages that were created as a result of the division performed by the content display module 101a-1. The timer generating module 101a-2 determines values for each of the plurality of page viewing periods based on the number of words on each page. According to one embodiment, other attributes such as, for example but not limited to, complexity (e.g., technology, science, terminology, etc.), readability index score, presence of images (e.g., pictures, drawings, charts, videos, graphs, etc.), font (e.g., size, type, color, etc.), may be considered in determining a page viewing period. In the case where text has been converted to speech, the page viewing period may be the length of time required to play the spoken text of a page to the user.

In another embodiment, the timer generating module 101a-2 obtains the page attributes from the content display module 101a-1. In yet another embodiment, the timer generating module 101a-2 obtains the page attributes from the metadata of the document. Consequently, one page of the document may have a different page viewing period than another page. For example, the first page of a document is an introduction (or background) to the subject matter of the document, while subsequent pages of the document include a deeper analysis of the subject matter. The timer generating module 101a-2 determines a shorter page viewing period for the first page, and larger page viewing periods for the more complex subsequent pages.

In yet another embodiment, the document includes an embedded video clip. If the video clip is the sole content of a page (i.e. no text in the same page), the timer generating module 101a-2 determines that the page viewing period for such page is equal to the amount of time it takes to view the entire video clip. In another embodiment, if there is more than one video clip on the page, the timer generating module 101a-2 sets the page viewing period to be the total time required to watch each of the video clips. In another embodiment, if the page includes both video and text, the timer generating module 101a-2 generates a page viewing period that includes the time to watch the video content plus the time required to read the text, for example, at the typical reading pace.

The credit approval module 101a-3 determines whether the user is eligible to obtain education credit. According to one embodiment, the credit approval module 101a-3 receives a communication from the timer generating module 101a-2 indicating that the document timer has reached the document viewing period. In response, the credit approval module 101a-3 determines that the user is eligible to obtain education credits. Subsequently, the credit approval module 101a-3 registers that the user has received education credit, and updates the user's education status accordingly.

According to another embodiment, the credit approval module 101a-3 receives from the timer generating module 101a-2 the amount of time that the user spent viewing each page. The credit approval module 101a-3 combines the total time for each page to compute a total document viewing time. Alternatively, the timer generating module 101a-2 may communicate the results of the document timer which corresponds to the total document viewing time.

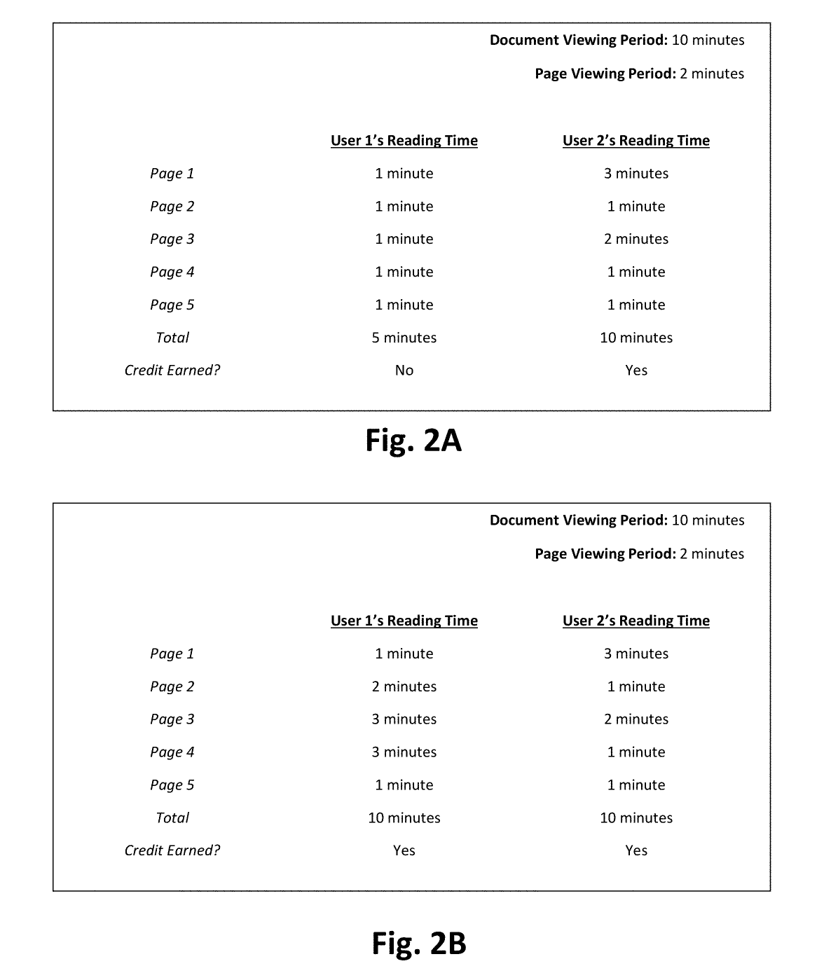

FIGS. 2A and 2B show an example where two users, user 1 and user 2, seek educational credit for reading the same 5-page document. For this example, it is assumed that the page viewing period for each of the 5 pages is 2 minutes each and the document viewing period is 10 minutes. Further, a user is allowed to turn to a subsequent page after viewing a previous page for 50% of the page viewing period (i.e. after 1 minute). FIG. 2A shows the users' viewing times at a first point in time. FIG. 2B shows the users' viewing times at a later point in time.

As shown in FIG. 2A, although user 1 has reached the last page by viewing each page for 1 minute, he or she is still not eligible for education credits because the total amount of time spent on the document is only 5 minutes, which is less than the document viewing period of 10 minutes. In contrast, user 2 spent more than 1 minute on one or more of the pages, accumulating a total amount of 10 minutes on the time spent viewing the document. Thus, user 2 is eligible for credit since user 2 has spent enough time to complete the document viewing period.

FIG. 2B shows that user 1 returned to the document at a later point in time, spending additional time viewing pages 2, 3 and 4. By accumulating additional viewing time, user 1 was able to meet the requirement of the document viewing period and receive CE credit for viewing the document.

According to a further embodiment, instead of or in addition to awarding CE credit when a user has viewed the entire document, CE credit is awarded based on the user viewing the document for a minimum time increment, for example, six minutes. Once a user has viewed a document for the minimum time increment, the viewer is credited. The user accumulates CE credit each time the user reaches a new minimum time increment.

Returning to FIG. 1A, the content publishing module 101a-4 publishes content created by content creators. For example, the content creators may be authors who create various types of documents such as, but not limited to, articles, stories, essays, columns, editorials, commentaries, and white papers. Documents may include images, audio, videos, or a combination thereof in addition to text. The content publishing module 101a-4 receive instructions from the content creators to publish the content so that it is accessible by users of the viewing verification application 101a.

As shown in FIG. 1A, the viewing authentication apparatus 101 communicates with a content database 102. The content database 102 registers or stores content (e.g., one or more documents) received from content creators. For example, when a new document is published by the content publishing module 101a-4, the document is stored in the content database 102. In addition, the content database 102 records information regarding the document such as its author, length, size, date created, date modified, etc. The content publishing module 101a-4 also stores statistical information regarding documents in the content database 102 as discussed below. Also, the content database 102 stores the document viewing period and page viewing periods generated by the timer generating module 101a-2. The document and page viewing periods may be stored as metadata associated with the documents stored in the content database 102.

As shown in FIG. 1A, the viewing authentication apparatus 101 is connected to network 107. The network 107 can be a local area network, a wide area network or any type of network such as an intranet, an extranet (for example, to provide controlled access to external users, for example, through the Internet), a private or public cloud network, the Internet, etc., or a combination thereof. In addition, the network 107 preferably uses TCP/IP (Transmission Control Protocol/Internet Protocol), but other protocols such as SNMP (Simple Network Management Protocol) and HTTP (Hypertext Transfer Protocol) can also be used. How devices can connect to and communicate over networks is well known in the art.

The terminal apparatus 103 as shown in FIG. 1A is connected with the viewing authentication apparatus via network 107. The terminal apparatus 103 can be any computing or viewing device, including but not limited to a tablet or notebook computer, a PDA (personal digital assistant), a mobile phone or handset, or another mobile information terminal, that can communicate with other devices through the network 107. The terminal apparatus 103 may be used by a content creator to access the viewing verification application 101a of the viewing authentication apparatus 101 in order to upload content (e.g., articles, videos, podcasts, images, etc.) for publishing. The terminal apparatus 103 may also be used by a user to access the viewing verification application 101a to earn CE credit. It should be appreciated that while only the terminal apparatus 103 is shown in the example of FIG. 1A, the system 100A can include more terminals. Indeed, the systems of this disclosure are preferably configured to be scalable such that terminals can be added to the system as desired and needed (e.g. to serve more users).

FIG. 1B shows schematically a system 100B, according to another embodiment. The system 100B is similar to the system 100A of FIG. 1A except that the system additionally includes a metrics management apparatus 104.

The content publishing module 101a-4 according to one embodiment monitors statistical data on documents accessed by users. For example, the content publishing module 101a-4 registers data regarding how often a document is viewed, the length of time users spent viewing the document, the types of users that viewed the documents (e.g., financial analysts, attorneys, accountants, corporate executives, individual investors, etc.), whether the document includes popular topics (e.g., taxes, ethics, law, finance, accounting, investing, securities, leadership, marketing, etc.), whether users have made comments about the document, and other factors that may be of interest to the certifying body or administrator.

The metrics management apparatus 104 receives metric information (e.g., statistics) from the viewing authentication apparatus 101 via the content publishing module 101a-4. For example, an organization that creates one or more documents may submit documents to be published by the viewing authentication apparatus 101. The organization also may be able or entitled to retrieve or receive the statistical information contained in the metrics management apparatus 104. According to one embodiment, the metrics management apparatus 104 communicates this information on command, or automatically at predetermined intervals (e.g., once per week).

FIG. 1C shows schematically a system 100C, according to another embodiment. The system 100C is similar to the system 100A of FIG. 1A except that the viewing verification application 101a additionally includes a detection module 101a-5.

The detection module 101a-5 detects whether a user is viewing the document. This detection may be performed to confirm that the user is viewing the document as opposed to viewing other items or performing other tasks while a document is displayed. According to one embodiment, the detection module 101a-5 detects when the user has not used an input device (e.g., keyboard, touchpad, computer mouse) for a predetermined period of time (e.g., 30 seconds). The absence of such input, which would normally be associated with a user scrolling through a document, is interpreted to mean that the user is not currently viewing the document. If no such input is detected during the predetermined time period, the detection module 101a-5 instructs the timer generating module 101a-3 to pause the page timer for the current page and the document timer. When a signal from an input device is next detected, the detection module 101a-5 instructs the timer generating module 101a-3 to resume the timers, thus resume measuring the page viewing and document viewing times.

The detection module 101a-5 may include one or more provisions to detect when the user is engaged in tasks other than viewing the document. In addition to, or alternatively to detecting the operation of an input device at the terminal apparatus 103, the detection module 101a-5 may also monitor whether the document is being displayed in an active window on the terminal apparatus 103. The detection module 101a-5 instructs the timer generating module 101a-3 to pause the page timer for the current page and document timer during the time that the document is not displayed in the active window. According to a further embodiment, the detection module 101a-5 will not send an instruction to pause the timers if selected applications not incompatible with a user reading a document are run on the terminal apparatus 103 while the document is being displayed, such as a music application.

According to another embodiment, the detection module 101a-5 accesses a camera on the terminal apparatus 103 to determine whether the user is not at a predetermined location or position for viewing the document on the terminal apparatus 103. If the detection module 101a-5 does not detect the user at the predetermined location or position, then the detection module 101a-5 determines that the user is not viewing the document. Again, the timer generating module 101a-3 is instructed to pause the page and document timers.

According to another embodiment, the detection apparatus includes image processing apparatus, for example, facial recognition technology to verify the identity of the individual viewing the document and to assure that the data is associated with the individual seeking and entitled to receive CE credit. According to another embodiment, the detection apparatus monitors the user's eye movement to confirm that the user's gaze moves through the document in a predetermined manner assumed to be consistent with the user reading the document.

FIG. 1D shows schematically a system 100D, according to another embodiment. The system 100D is similar to the system 100A of FIG. 1A except that the viewing verification application 101a additionally includes a user interface 101a-6 and the system additionally includes a certification management apparatus 106.

The user interface 101a-6 allows the user to access the features offered by the viewing verification application 101a (such as the content display module 101a-3) via a graphic user interface (GUI). According to one embodiment, the user is presented with information indicating which of a plurality of published documents may be viewed to obtain CE credit. The user interface 101a-6 also displays the user's status regarding the number of education credit hours that the user has accumulated and the additional time required to complete a next education credit hour.

The certification management apparatus 106 records education credits accumulated by users. According to one embodiment, the system is utilized by individuals who seek CE credits in order to achieve and/or maintain certification by a professional organization or certifying body. For example, the user may be a certified financial planner (CFP) that is certified by the Certified Financial Planner Board (CFP Board). According to this embodiment, the viewing verification application 101a offers such users the opportunity to earn CE credit that is recognized as valid by the CFP Board. According to a further embodiment, users may be qualified to receive CE credits from multiple professional organizations or certifying bodies. For example, the financial professional may also be entitled to receive CE credit accredited by the Chartered Institute for Management Accounting (“CIMA”) in addition to CE credits accredited by the CFP Board.

A professional organization or certifying body (such as the CFP Board) may allow an administrative entity operating the viewing authentication apparatus 101 to independently accredit content and/or certify documents as suitable for users (such as CFPs) to earn education credits. The administrative entity reviews documents submitted to it by authors such as financial industry experts to assure that they conform to guidelines set by the professional organization or certifying body. The administrative entity publishes those documents via the viewing authentication apparatus 101. The professional organization may audit the entity to assure that the entity is complying with the organizations guidelines and that the published content meets the standards of the professional organization.

In yet another embodiment, the certification management apparatus 106 receives updates from the viewing authentication apparatus 101 that a user has earned education credit minutes or education credit hours. For example, when a user has completed viewing a document provided by the viewing verification application 101a and has spent the requisite time viewing the document, the user accumulates education credits. The viewing verification application 101a communicates the number of education credits accumulated by the user to the certification management apparatus 106. The certification management apparatus 106 may communicate that educational credit information to the professional organization and may also publish a certificate or certification data, send the certificate or data to the user, or make the certificate or data available. According to one embodiment, the certification management apparatus 106 communicates educational credit information to the professional organization at regular intervals (e.g., once per week), or makes it available for access on command. Where a user accumulates CE credits for multiple organizations (e.g. CFP and CIMA), CE credit accumulated by the user is communicated to each organization.

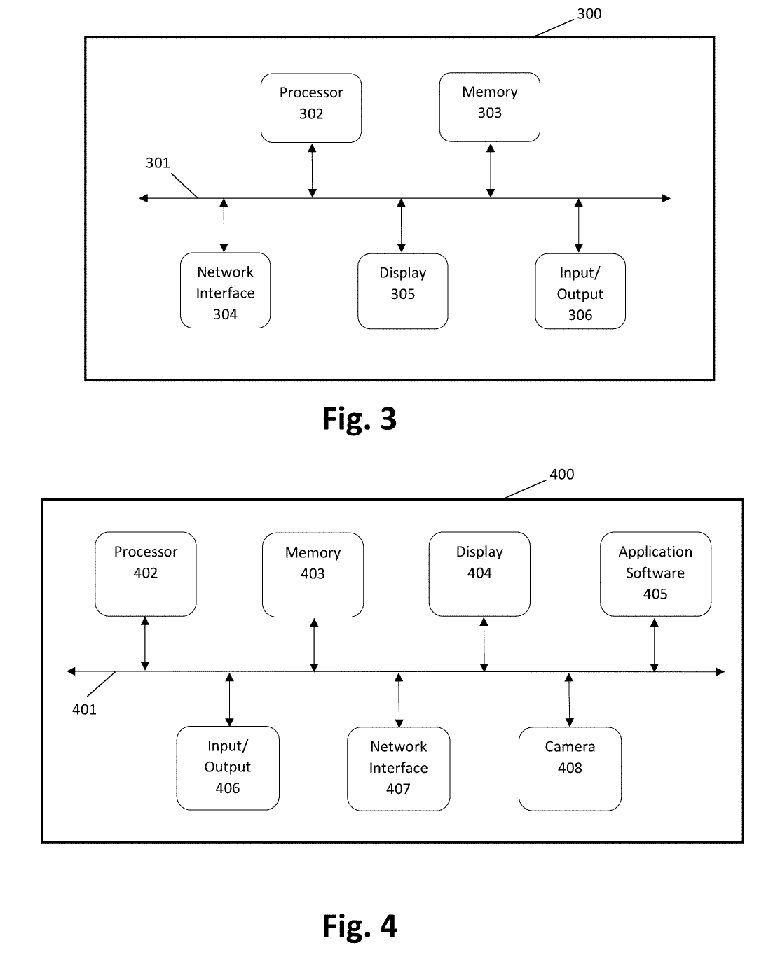

FIG. 3 shows a constitution of a computing device that is configured (for example, through software) to operate (at least in part) as a viewing authentication apparatus (e.g., 101 in FIGS. 1A-1D), a metrics management apparatus (e.g., 104 in FIG. 1B), and/or a certification management apparatus (e.g., 106 in FIG. 1D). In FIG. 3, apparatus 300 includes a processor (or central processing unit) 302 that communicates with a number of other components, including memory or storage device 303, network interface 304, display 305, other input/output (e.g., keyboard, mouse, touchpad, etc.) 306, by way of a system bus 301.

The apparatus 300 may be a special-purpose device (such as including one or more application specific integrated circuits or an appropriate network of conventional component circuits) or it may be software-configured on a conventional personal computer or computer workstation with sufficient memory, processing and communication capabilities to operate as a terminal and/or server, as should be appreciated by those skilled in the relevant art. In the management apparatus 300, the processor 302 executes program code instructions that control device operations. The processor 302, memory/storage 303, network interface 304, display 305, input/output 306 are conventional, and therefore in order to avoid obfuscating the inventive aspects of this disclosure, such conventional aspects are not discussed in detail herein.

The apparatus 300 includes the network interface 304 for communications through a network, such as communications through the network 107. However, it should be appreciated that the subject matter of this disclosure is not limited to such configuration. For example, the apparatus 300 may communicate with user terminals through direct connections and/or through a network to which some components are not connected. As another example, the apparatus 300 does not need to be provided by a server that services terminals, but rather may communicate with the devices on a peer basis, or in another fashion. The apparatus 300 of the present disclosure is not limited to a server or computer, but can be manifested in any of various devices that can be configured to communicate over a network and/or the Internet.

A constitution of the terminal apparatus 103 of FIGS. 1A-1D is shown schematically in FIG. 4. In FIG. 4, terminal 400 includes a processor (or central processing unit) 402 that communicates with various other components, such as memory (and/or other storage device) 403, display 404, application software 405, input/output (such as keyboard, mouse, touchpad, stylus, microphone and/or speaker with voice/speech interface and/or recognition software, etc.) 406, network interface 407 and camera 408, by way of an internal bus 401.

The memory 403 can provide storage for program and data, and may include a combination of assorted conventional storage devices such as buffers, registers and memories, for example but not limited to, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM).

The display 404 can be any of various conventional displays (such as a liquid crystal display, a plasma display device, a cathode ray tube display, etc.), but is preferably equipped with a touch sensitive display (for example, liquid crystal display), and configured to provide the GUI for use by a user of the terminal 400.

The application software 405 is shown as a component connected to the internal bus 401, but in practice are typically instructions stored in storage media such as a hard disk or portable media, and/or received through the network, and loaded into memory 403 as the need arises.

The network interface 407 provides a connection (for example, by way of an Ethernet connection or other network connection which supports any desired network protocol such as, but not limited to TCP/IP, IPX, IPX/SPX, NetBEUI, etc.) to the network to which the computer 400 is connected (e.g., network 107 of FIGS. 1A-1E).

The camera 408 is, for example, a digital camera including one or more lenses, an image sensor for converting an optical image into an electrical signal, an image processor for processing the electrical signal into an image signal, and a storage medium for storing the images. The series of lenses focus light onto the sensor (e.g. a semiconductor device such as a charge-coupled device (CCD) image sensor or a complementary metal-oxide-semiconductor (CMOS) active pixel sensor) to generate an electrical signal corresponding to an image of a scene. The image processor then analyses the electronic information, creating an image in a digital format. The camera 408 or other components of the apparatus 400 may include digital signal processing software or hardware to provide functionality discussed below including identifying an individual user and/or assuring that a user is located near the terminal apparatus 103.

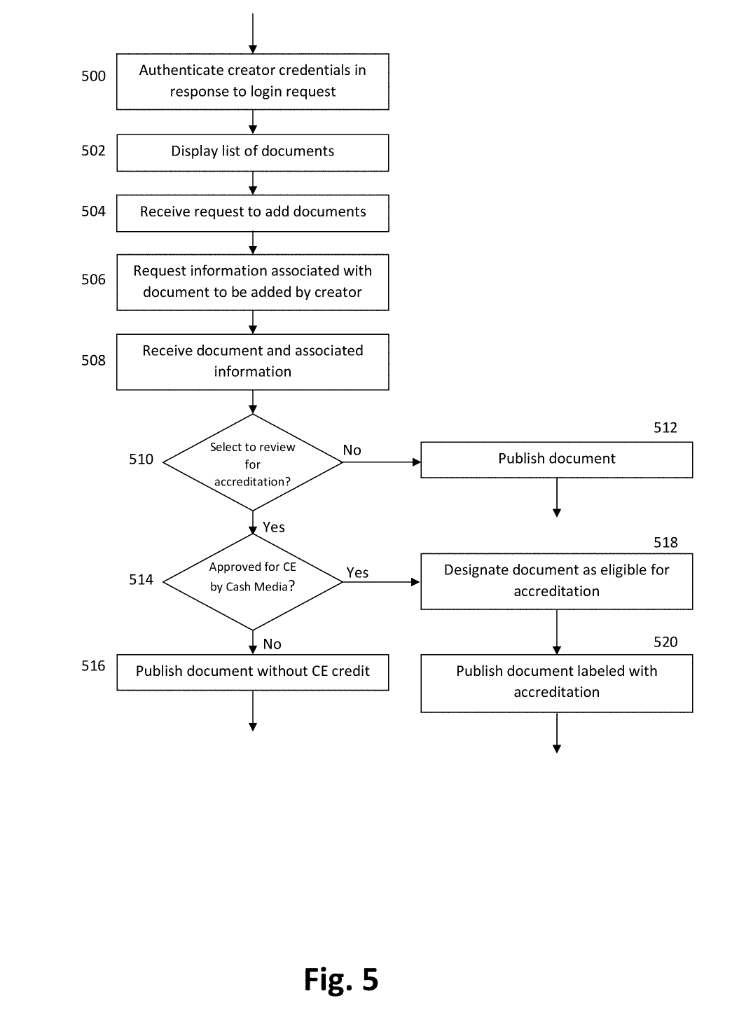

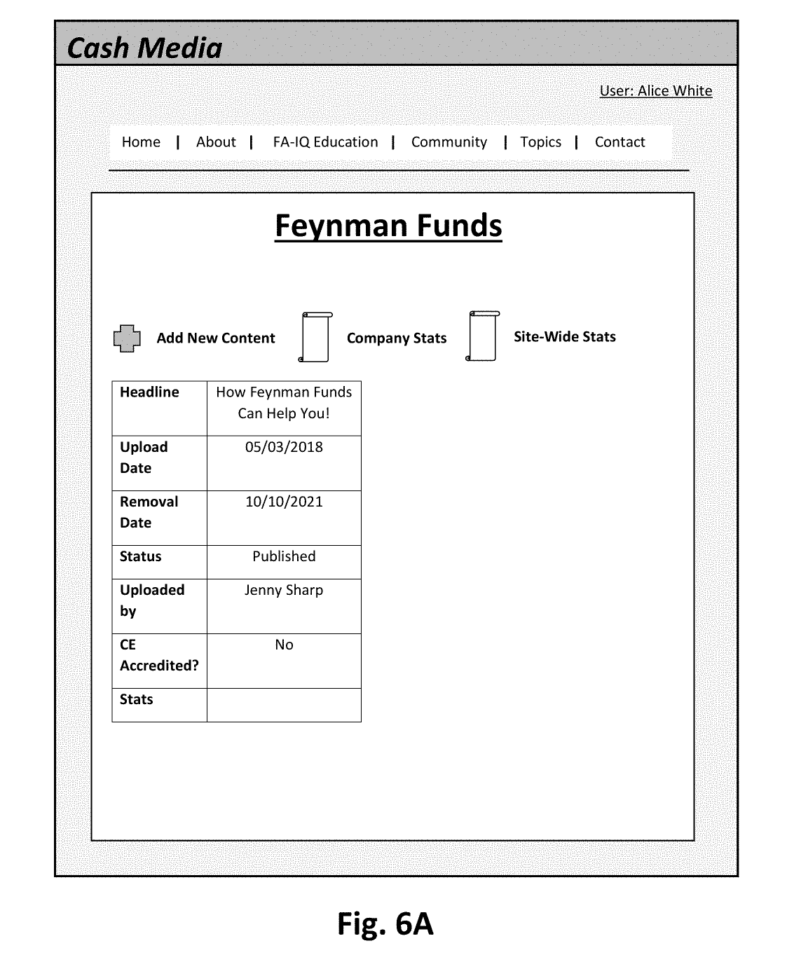

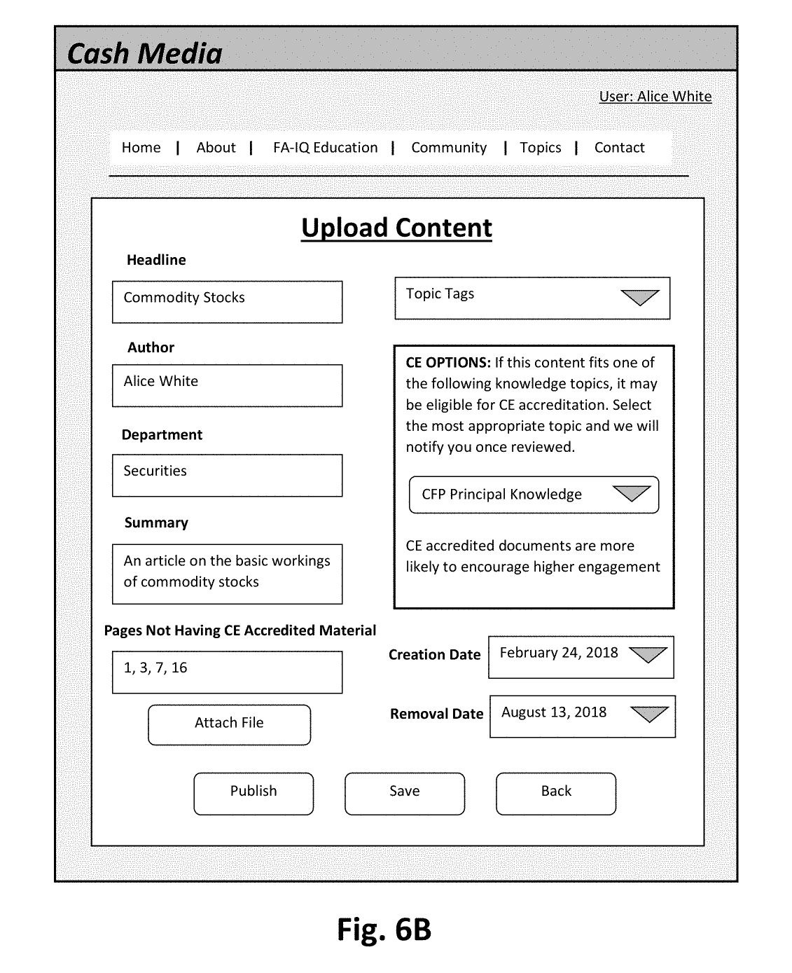

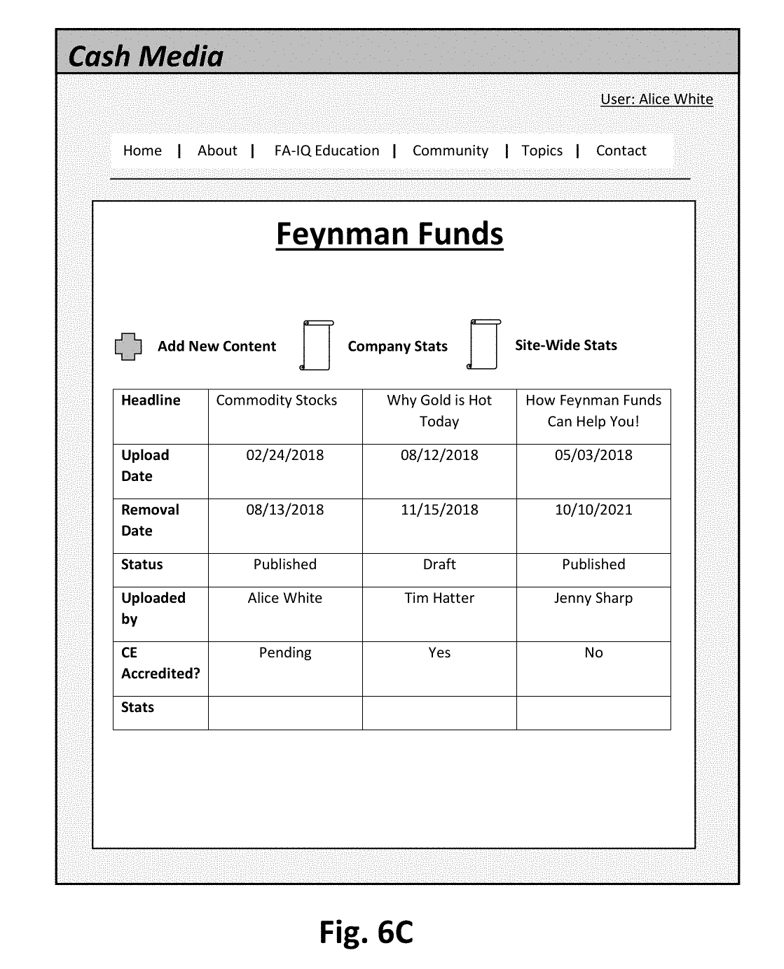

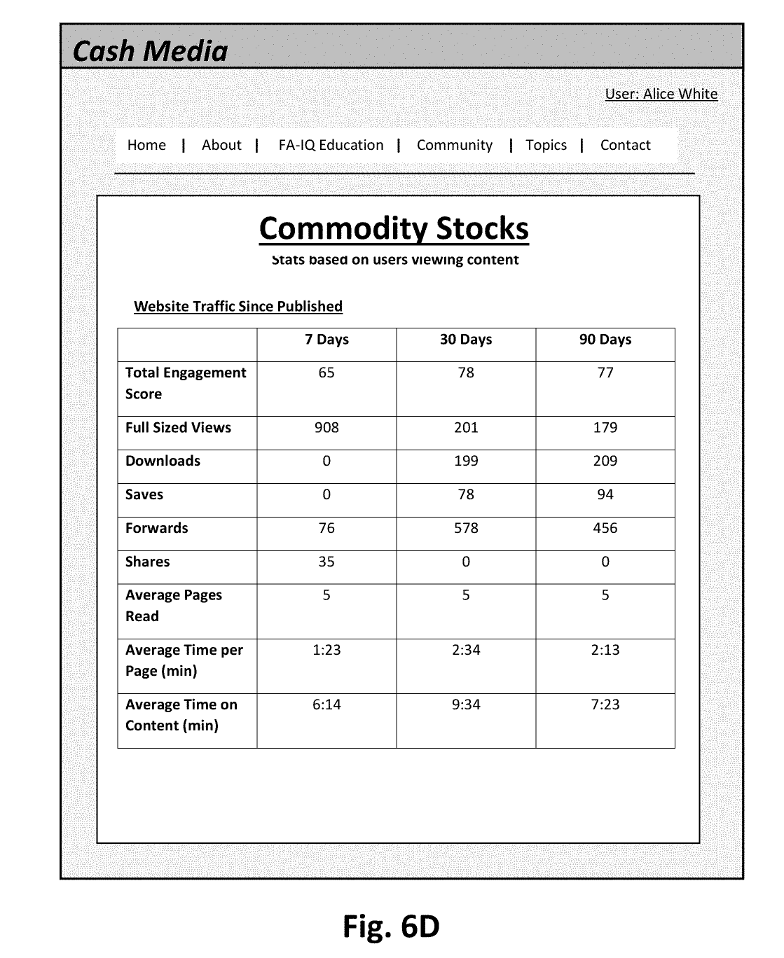

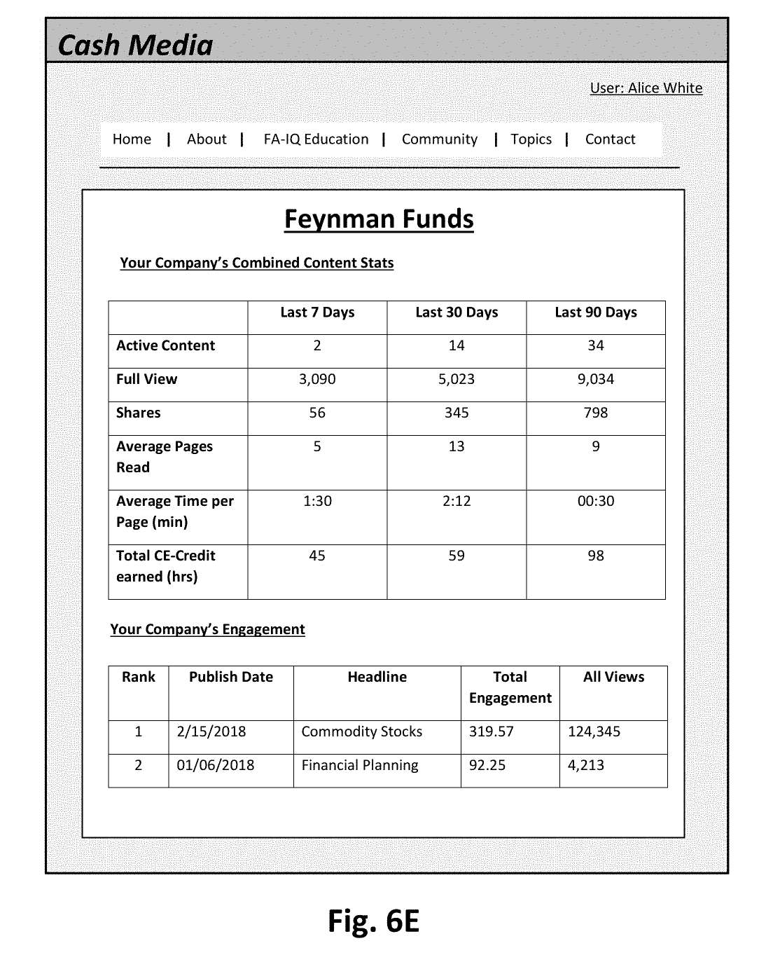

FIG. 5 shows an event process or workflow performed by a viewing verification application (e.g., 101a), according to an embodiment. FIGS. 6A-E show screens that may be displayed to users according to a scenario.

In this exemplary scenario, investment organization Feynman Funds (a fictitious entity for purposes of illustration) instructs their employees (e.g., analysts, financial advisors, etc.) to create content (e.g., articles, commentaries, papers, editorials, columns, etc.) relevant to the investment community. Such content is published under the Feynman Funds name and may, for example, be posted on their website or distributed to different news outlets (e.g., Financial Times, etc.). The expectation is that others including investors, financial advisors, and financial planners will read such published content and develop a reliance and/or appreciation for the concepts, strategies, advice, or perspectives of Feynman Funds that are embodied by such published content.

According to this scenario, Cash Media (a fictitious entity for purposes of illustration), which operates and administers viewing authentication apparatus 101 as described above, receives content distributed by Feynman Funds. Cash Media offers users who are certified financial planners or certified financial advisors the opportunity to earn CE credits that are required by one or more accrediting organizations, for example, the CFP Board, the Certified Financial Advisors (CFA) Institute, or the CIMA. As described below, Cash Media verifies that users have viewed the required CE content using the viewing verification apparatus 101.

While the embodiments are described with regard to providing CE credits to financial planners and advisors, the subject matter of the disclosure is not limited to this field. It should be noted that CE credits are not unique to the field of certified financial planners/advisors. Many professional organizations require that members complete CE credits. For example, attorneys are typically required by state bar associations to complete a certain amount of continuing legal education (CLE) credits to be in good standing to practice law in that state. The present disclosure is applicable to verifying education credits in other fields including but not limited to law, medicine and engineering. In addition, the disclosure is applicable to other educational settings, for example, schools, colleges, and universities where individuals are presented with educational materials via electronic communication and there is a need for the users to demonstrate that they have viewed such material for a length of time determined to be sufficient to read and comprehend the subject matter of the materials.

In this scenario, an employee at Feynman funds who creates content (the creator) is provided with an authorized account. At step 500, the creator logs onto the system operating the viewing authentication apparatus 101 by presenting his or her login credentials (e.g., user name and password). For example, as shown in FIG. 6A, the creator (e.g., Alice White) is an employee of Feynman Funds. After Alice successfully logs into her creator account, she is presented with a list of documents and information about those documents that were previously uploaded by her and/or one or more of her coworkers (e.g., Jenny Sharp) at step 502. It should be note that while the list of FIG. 6A displays only one document for convenience, there may be a plurality of documents on the list.

The creator, Alice, sends a request to the viewing authentication apparatus 101 to add content at step 504. In response, the viewing verification application requests information from the creator regarding the document that is to be added at step 506 and receives such information at step 508. For example, as shown in FIG. 6B, this information includes “Headline”, “Author”, “Creation Date”, “Removal Date,” etc. The “Creation Date” may be the date that the document is created or uploaded. The “Removal Date” may be the date on which the document will be automatically deleted or “unpublished” (i.e. removed from public viewing, but not deleted). In addition, the creator selects whether the content should be considered eligible for CE accreditation at step 510. As shown in FIG. 6B, a pull-down menu of categories related to “CFP Principle Knowledge” is provided. If the creator wishes to submit the document for CE Credit, the creator also designates which pages of the document do not include CE accredited material, e.g., the title page, end notes, marketing materials, disclaimers, etc. According to a further embodiment, the viewing authentication apparatus identifies pages of the document that do not contain CE accreditation materials based on characteristics of the document, e.g. keywords (sections beginning with terms such as “Abstract,” “Disclaimer,” “Endnotes,” etc.) or metadata contained in the document. According to a further aspect, the application conducts analysis of the document by artificial intelligence to identify portions that do not contain CE accredited material. Once the portions of the document that do not include CE accreditation material are identified, the viewing authentication apparatus determines whether the portions of the document that include CE accreditation materials include a sufficient quantity of text or other information to qualify the document as providing CE credit.

According to a further embodiment, if a creator wishes to submit a document to provide CE credit for multiple accrediting organizations (e.g., CFP Board and CIMA), the creator is provided with a box (not shown) to identify which organizations may award CE credit for viewing the document. The criteria for accrediting content (e,g., knowledge topics, word count etc.) may differ for each accrediting organization. The creator is provided with a box (not shown) to enter the required information for each of the organizations. Creators can update an existing accredited document to add or remove designation for accrediting organizations.

Should the creator elect to have the document considered for CE credit (step 510, yes), he or she selects one or more areas of CE principle knowledge relevant to the document. If the creator elects not to submit the document for CE credit (step 510, no), the viewing verification application publishes the document without designating that the document is accredited at step 512. After submitting the content, the creator is presented with an updated list of documents shown in FIG. 6C. In one example, the creator may be notified that the document is still in the review process by the indicator “pending.” Should the user submit the document for accreditation, Cash Media determines at step 514 whether the document is eligible. Where multiple accrediting organizations are designated, Cash Media determines whether the document is eligible according to each organization's criteria. If Cash Media does not approve the document at step 514 (no), the viewing verification application 101a publishes the document without CE credit at step 516. If Cash Media approves the document at step 514 (yes), the viewing verification application 101a designates the document as eligible for CE credit at step 518. Where CE credit is available from multiple organizations, an indication (not shown) is provided identifying which accrediting organizations will recognize CE credit earned by viewing the document. Then, the viewing verification application 101a publishes the document labeled with accreditation status at step 520.

In an embodiment, the content creators are presented with metrics (e.g., statistics) of documents that have been uploaded. For example, as shown in FIG. 6D, the creator may view metrics regarding the article (i.e. “Commodity Stocks”) that had previously been submitted. In this case, the user may be presented with a variety of information in connection with the article, including but not limited to shares, forwards, average number of pages read, and average time spent viewing the content.

In another embodiment, metrics regarding all of the content submitted by Feynman Funds may be accessed, as shown in FIG. 6E. For example, managers or executives of Feynman Funds may utilize such statistical data to determine how to improve future content or how to better serve the needs of readers and potential customers. In another example, Feynman Funds may identify which topics (and articles) are most frequently viewed so that Feynman Funds can create more content that is directed towards such topics. According to embodiments where CE credits from multiple accrediting organizations are available via the viewing verification apparatus, metrics and statistic regarding documents viewed for CE credit for each of the accrediting organizations are provided to the creator and/or to the creator's employer.

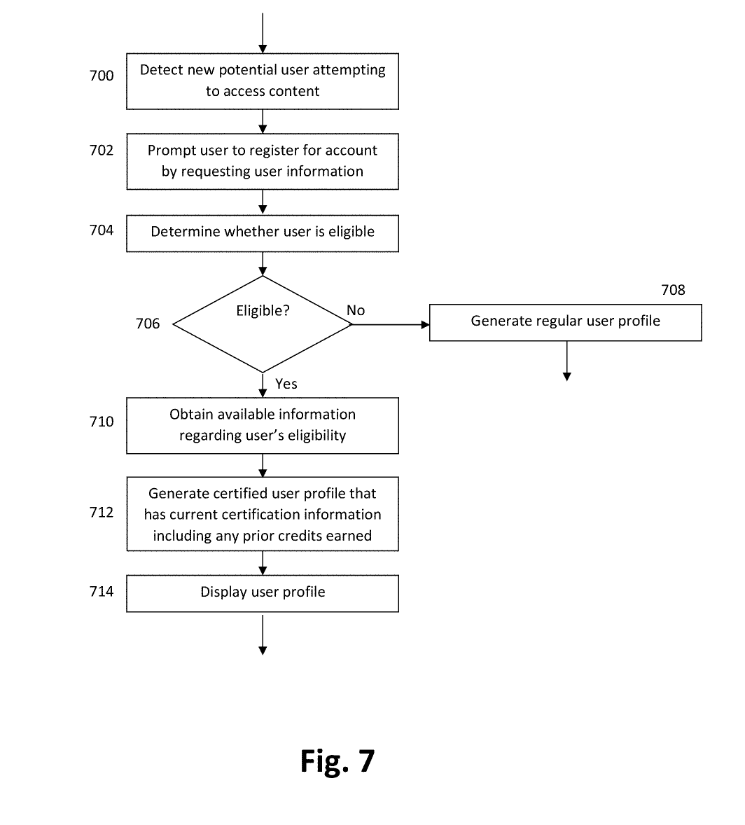

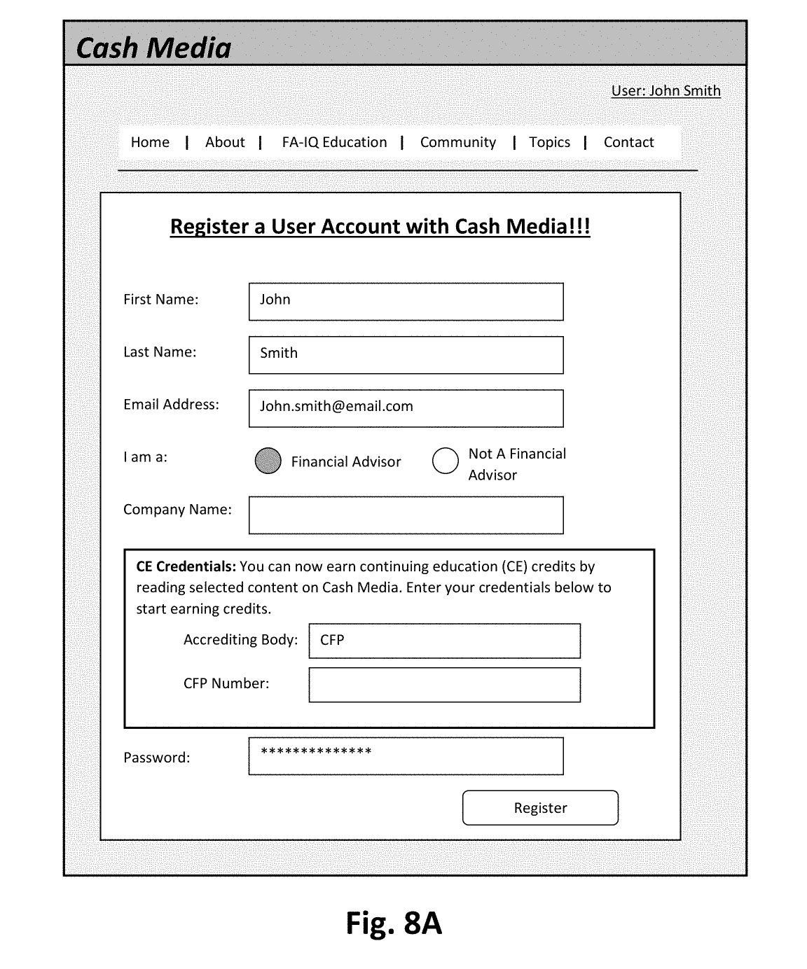

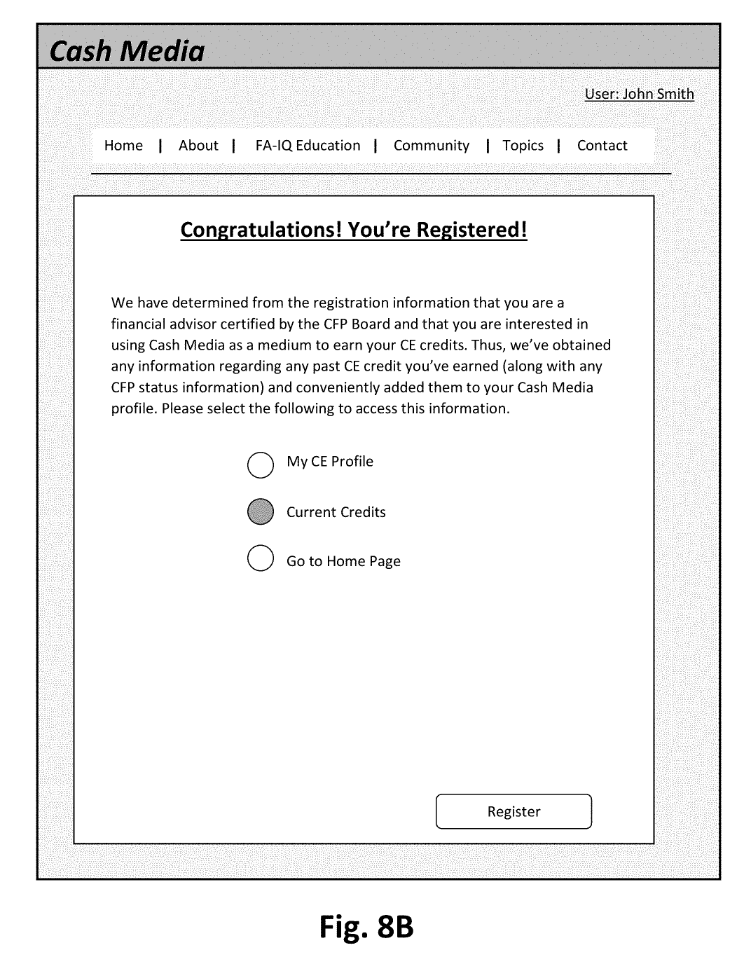

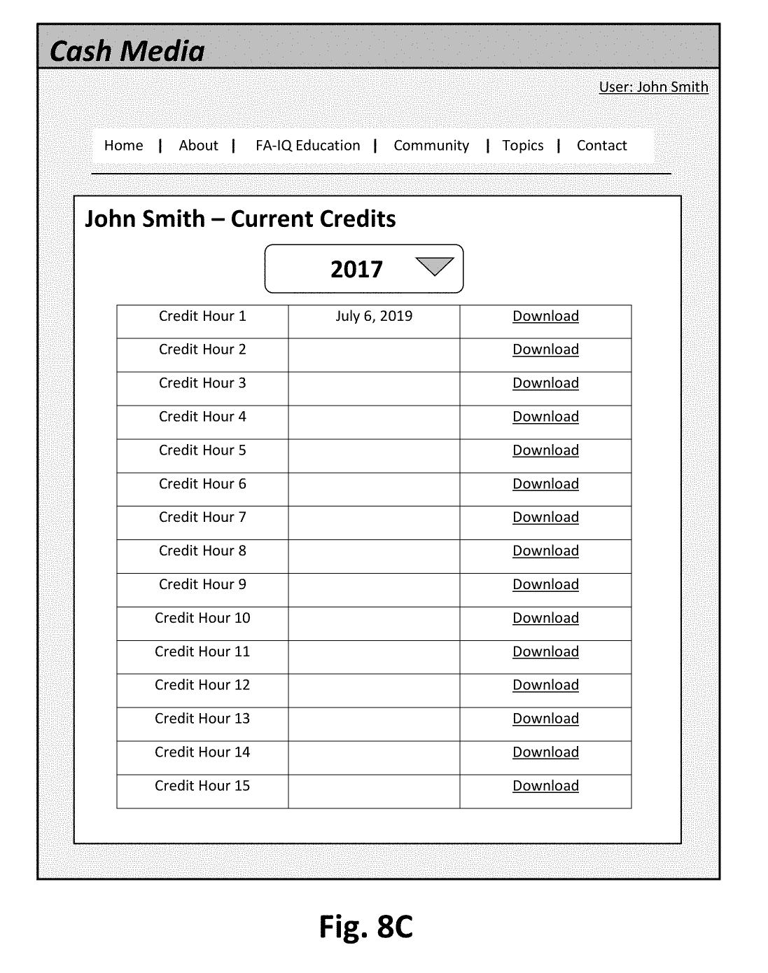

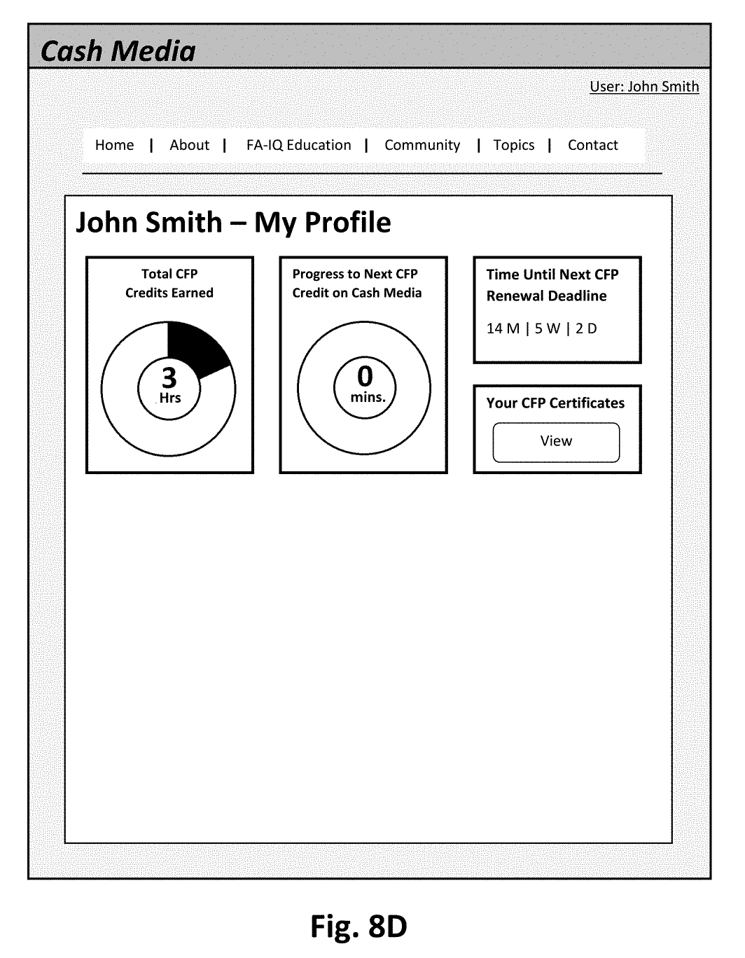

FIG. 7 shows an event process or workflow performed by a viewing verification application (e.g., 101a), according to an embodiment. FIGS. 8A-D show screens that are presented to a hypothetical user in a scenario using the workflow shown in FIG. 7. According to the scenario, a user (John Smith) is assumed to be a certified financial planner (CFP) who is required to complete a predetermined number of hours of continuing education (CE) credits per year. It is also assumed that John has not previously registered to receive CE credits with Cash Media, the entity operating the viewing authentication application.

As shown in FIG. 7, the process commences when the viewing verification application detects at step 700 that a potential new user is attempting to access content (e.g., going to the website or launching the application) provided by the viewing verification application 101a. In response, the viewing verification application prompts the user to register for an account and requests user information at step 702. For example, as shown in FIG. 8A, John is asked to provide basic user information (e.g., name, email address, etc.). Further, he is asked if he is a financial advisor, and if so, to provide his CFP credentials (e.g., CFP Registration Number). Where the document is determined to provide CE credits for multiple accrediting organizations, the user is asked to provide identifying credentials for each of those organizations.

After receiving user information, the viewing verification application 101a determines whether the user is eligible to seek and receive education credits at step 704. In the case that the user is not eligible at step S706 (no), the viewing verification application 101a generates a regular user profile for the user at step 708. In this example, John is a CFP and is eligible (step S706, yes). The viewing verification application 101a obtains available information regarding the user's eligibility to seek and receive CE credits such as by verifying John's identity and a CFP registration number at step 710. According to one embodiment, the viewing verification application 101a retrieves information from a database maintained by the CFP Board to verify the user's identity and/or to confirm that the user is indeed a CFP eligible to receive CE credit. Next, the viewing verification application 101a generates a certified user profile including the user's current certification information at step 712. The profile may include CE credits previously earned by the user that are retrieved by the viewing verification application 101a from the CFP Board database.

After the user has performed registration, the viewing verification application displays a message at step 714 stating that his or her profile has been populated with information regarding his or her certification including any past credits that may have been accumulated, as shown in FIG. 8B. Further, the viewing verification application gives the user the opportunity to review his or her certified user profile or current CE credits by providing corresponding radio buttons. For example, in the case that the user selects to view his or her current CE credits, a list of earned CE credits is displayed, as shown in FIG. 8C. The list of earned CE credits may include credits earned from viewing content administered by Cash Media and from other sources external (outside) of Cash Media.

In another example, in the case that John selects to view his profile (“My CE Profile” in FIG. 8B), he is presented with information, as shown in FIG. 8D, including, the total amount of CE credits he has earned, his progress to earning his next CE credit hour, and the time period before his next renewal deadline. He is also provided with a link that will allow him to view his previously earned CE Certificates. According to embodiments where CE credits from multiple accrediting organizations are available via the viewing verification apparatus, the user is presented CE credit information for each organization for which he is authorized to receive CE credit.

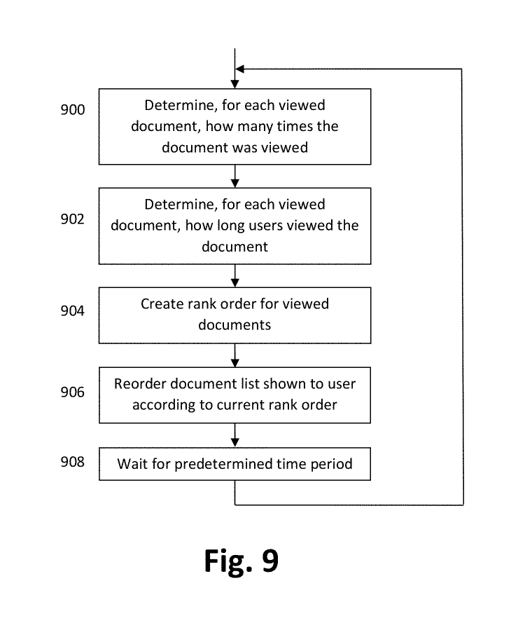

FIG. 9 shows an event process or workflow performed by a viewing verification application (e.g., 101a), to determine the order in which documents appear in a list of documents available for viewing.

The viewing verification application determines, for each viewed document, how many times such document was viewed at step 900. Next, the viewing verification application 101a determines, for each viewing of the documents, how much time users have spent viewing the document, that is time per view at step 902. After the viewing verification application 101a determines, from the viewing information, the number of views and the time per view for each document, the viewing verification application 101a creates a rank order for the documents to present near the top of the list those documents which have been demonstrated to be of greater interest to users. According to one embodiment, a weighted combination of number of views and the time per view for each document is used to rank order the documents.

According to a further embodiment, a ranking of documents may be determined by other criteria, for example, whether users printed the document or shared the document with others. The viewing verification apparatus 101a assigns a point value to documents based on actions taken by users who view the document. The table such as the one below may be used to assign points for documents.

| | Point | |
|---|---|---|
| Action | Value | Requirement Notes |
| View | 1 | Document is viewed by user |
| Save | 1 | ‘Save’ is clicked on a document by user |
| Download & Print | 3 | Download & Print link is clicked by user |
| Email Forward | 5 | A PDF link email forward is sent by user |
| Post on Social | 5 | A PDF link is shared on any of the Social |
| Media | | Media options available. 5 points per each |
| | | Social Media share |
| 1-star rating | 1 | Based on the ‘Star’ rating system. |
| 2-star rating | 2 | |
| 3-star rating | 3 | |
| 4-star rating | 4 | |
| 5-star rating | 5 | |

For example, each time a document is viewed by a user it accumulates 1 point. Each time it is shared by a user on social media the document accumulates 5 points. Also, users are asked to rank documents on a “star” rating scale and a document that receives, for example, a 3-star rating would accumulate 3 points. Documents are then rank ordered based on the number of points accumulated. According to a further embodiment, the accumulated number of points for a document would “decay,” that is, would diminish over time so that if a document did not continue to receive views, social media shares, star ratings, etc. its rank would diminish. This causes documents that receive views, social media shares, rankings, etc. more recently to rise in ranking above documents that may become of less interest to users as time passes.

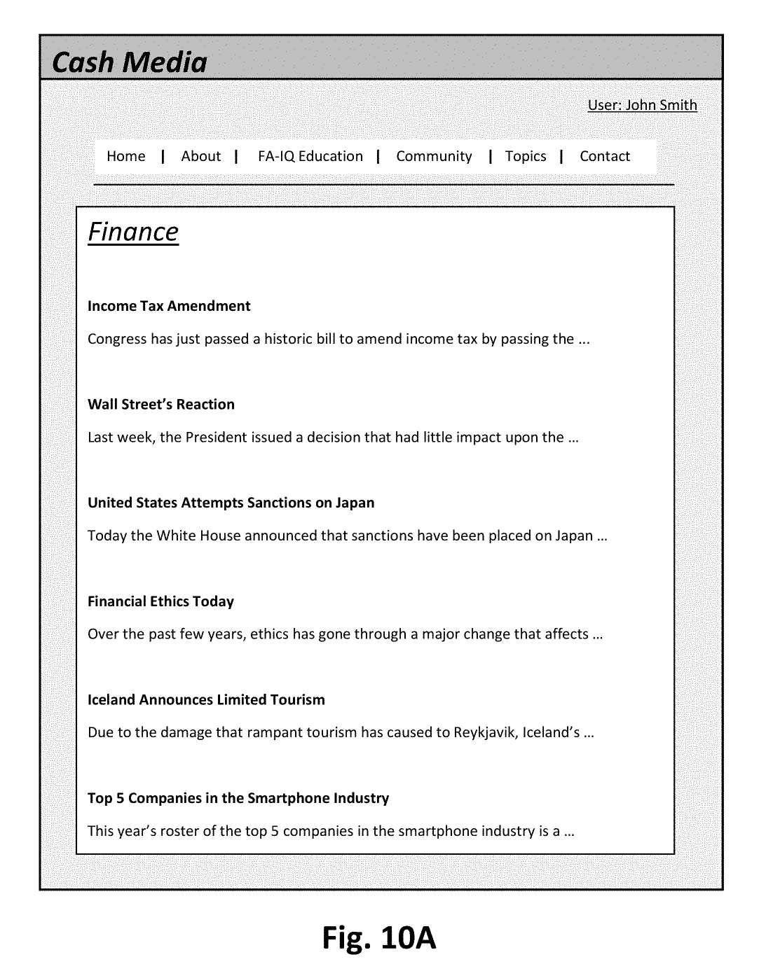

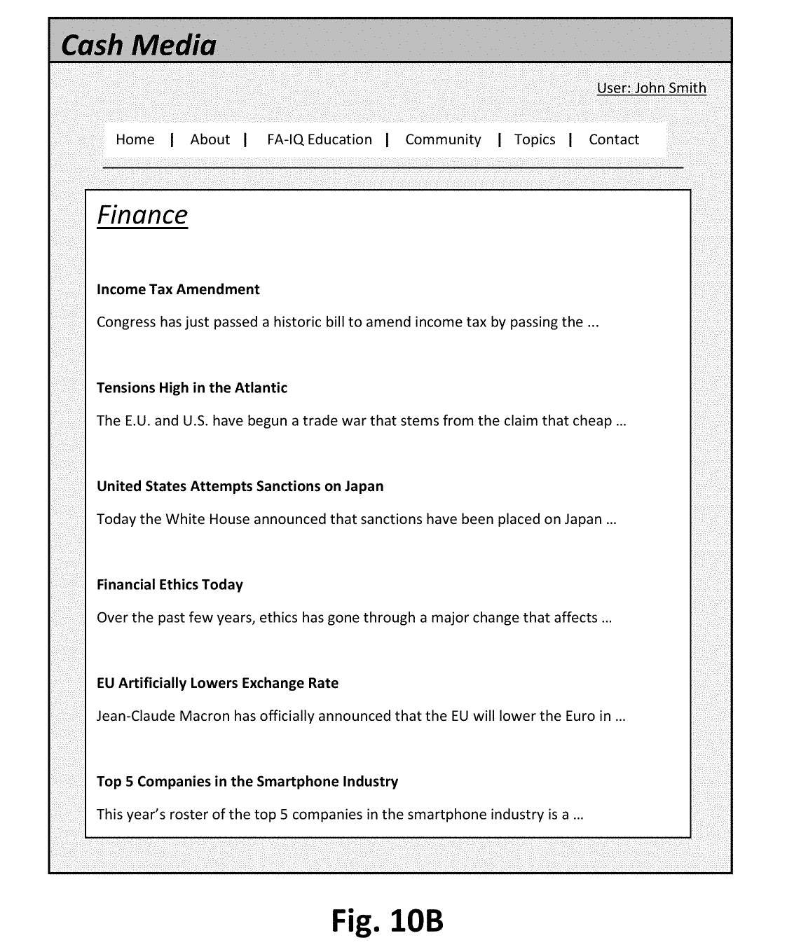

After the viewing verification application 101a determines the rank order, the viewing verification application reorders the list of documents according to that determination. For example, as shown in FIG. 10A, the topmost list of articles shown to users upon accessing the viewing verification application 101a are currently determined to be the articles that are viewed most frequently and/or for the longest periods of time. Alternatively, the documents could be ordered based on the highest accumulated number of points assigned, for example, according to the scheme shown in regard to the table above. At step 908, after a predetermined period of time (e.g., 30 seconds), the viewing verification application 101a reviews viewing data and again reorders the list. For example, as shown in FIG. 10B, the viewing verification application 101a has replaced one or more articles (e.g., “Wall Street's Reaction”) appearing near the top of the list with newly determined recommended documents (e.g., “Tensions High in the Atlantic”).

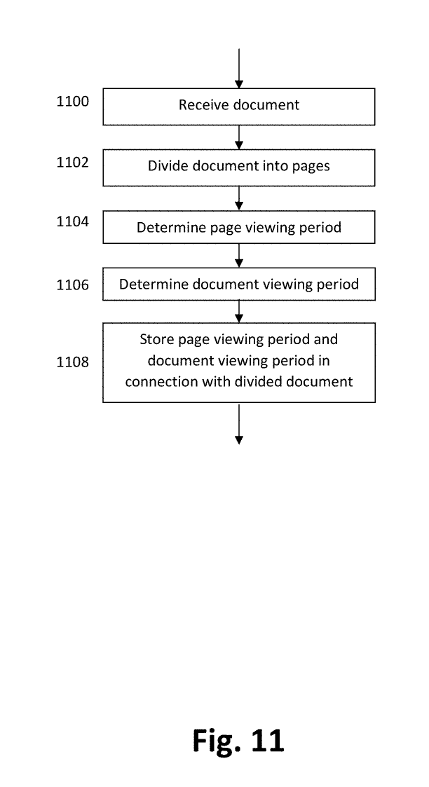

FIG. 11 shows an event process or workflow performed by a viewing verification application (e.g., 101a), according to an embodiment for receiving and processing a new document.

The viewing verification application 101a receives a document from a creator at step 1100. According to one embodiment, documents are converted to a format that allows the viewing verification application 101a to control how a user can interact with the document. One such format is, for example, hypertext markup language (html). Documents received at step 1100 are converted from their original format to html. The viewing verification application 101a divides the document into one or more pages for display to the user at step 1102. If the document is received in a file format that inherently includes pages (e.g., .pdf, .doc, .djvu, etc.), the original pagination is preserved when the document is converted to html. For example, if the original document is in a pdf file format that includes 10 pages, the viewing verification application 101a will create an html document divided into the same 10 pages.

Next, the viewing verification application 101a determines a page viewing period at step 1104. The page viewing period is determined based on characteristics of each page of the document. According to one embodiment, the system calculates or is provided with an assumed reading speed that is based on the amount of time required for an ordinary reader to comprehend the content contained in the material. Such a reading speed could be from 100 words per minute to 300 words per minute. According to one embodiment, a typical reading rate of 150 words per minute may be assumed. At step 1104, the viewing verification application 101a calculates a page viewing period for each page of the document based on the number of words on each page. If the 10-page article discussed above has 450 words per page, the viewing verification application 101a would determine the page viewing period to be 3 minutes (i.e. 450 words/150 words per minute) for each page. The number of words for each page may vary, thus the page viewing period may be different for each page. In an embodiment, in the case that the page viewing period is determined not to be a whole minute, the viewing verification application 101a is rounded up to nearest minute.

Then, the viewing verification application 101a determines a document viewing period at step 1106. The document viewing period is likewise determined based on an assumed typical reading speed and the total number of words in the document. For example, for an assumed reading speed of 150 words/minute and the same 10-page document discussed above with 4,500 words in total (i.e. 450 words per page times 10 pages), the document viewing period would be 30 minutes. In one embodiment, the document viewing period is the total of the page viewing periods. In another embodiment, the document viewing period is longer than the total of the page viewing periods, for example, where the viewing verification determines that the complexity of the document would require additional time for a user to fully comprehend the information presented in the document. As will be discussed below, the amount of CE credits a user is entitled to earn upon completion of viewing a document is determined by the document viewing period.

The viewing verification application 101a stores the document viewing period and page viewing periods for the document along with the document itself in the content database 10 (shown in FIG. 1A) at step 1108. In an embodiment, the viewing verification application 101a registers the document viewing period and the page viewing period as the document's metadata.

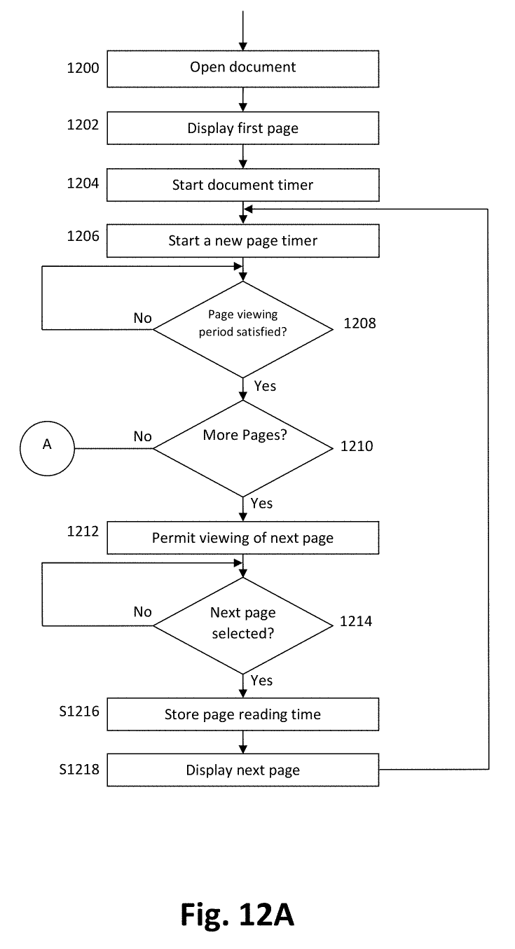

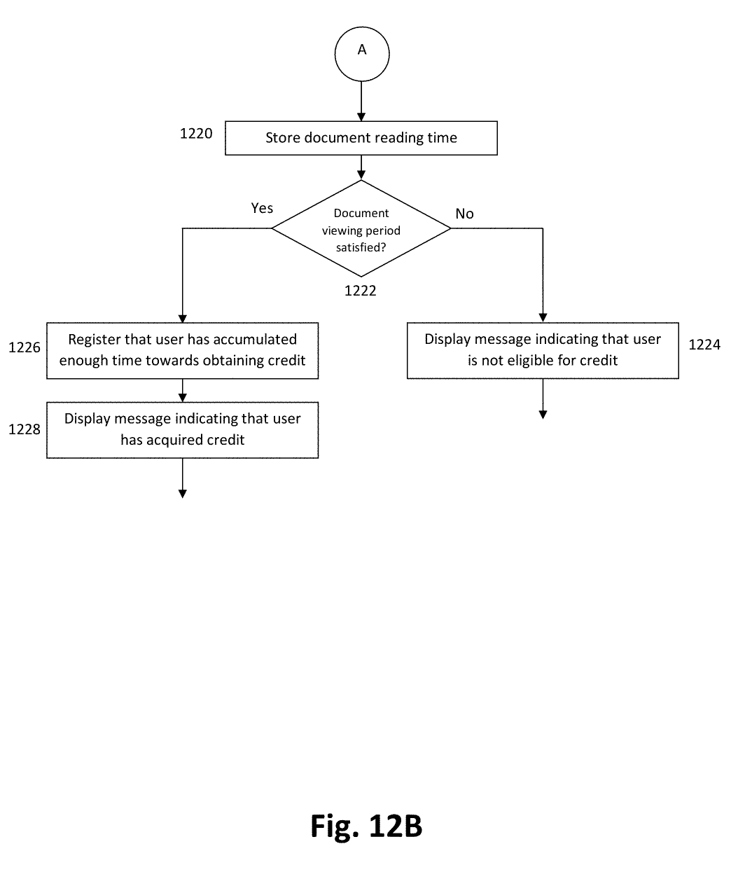

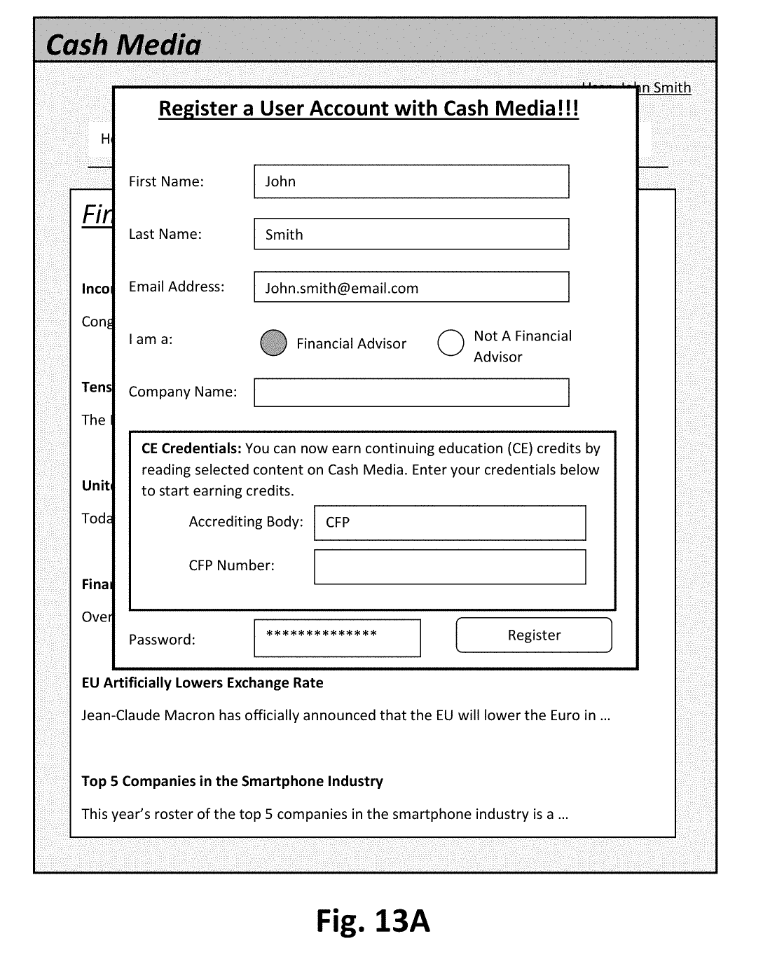

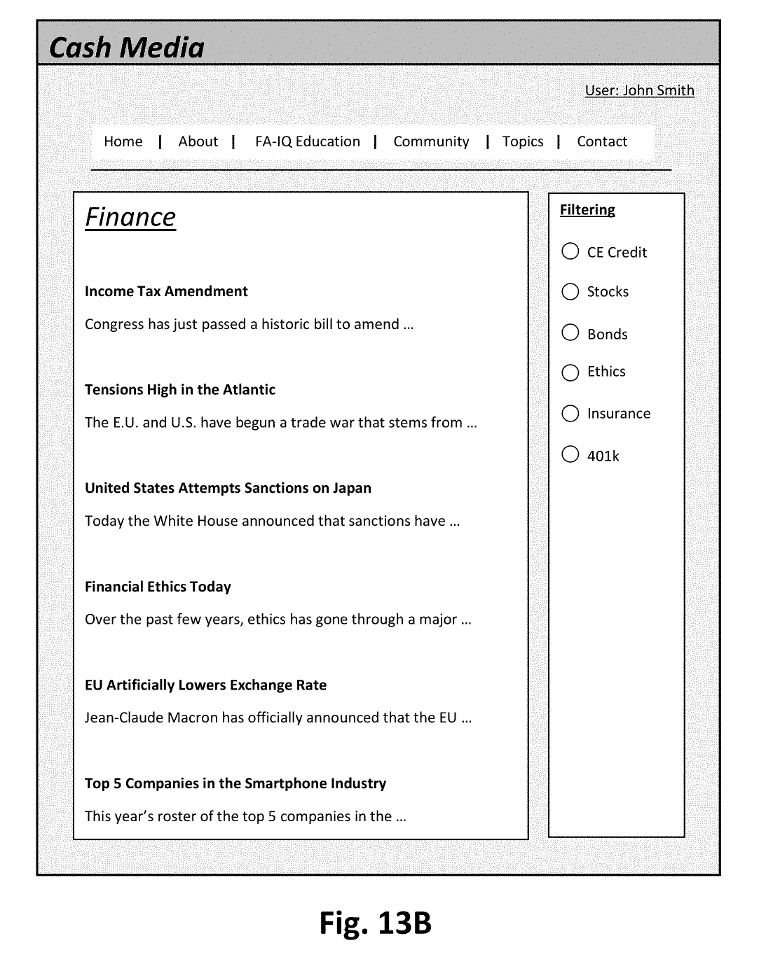

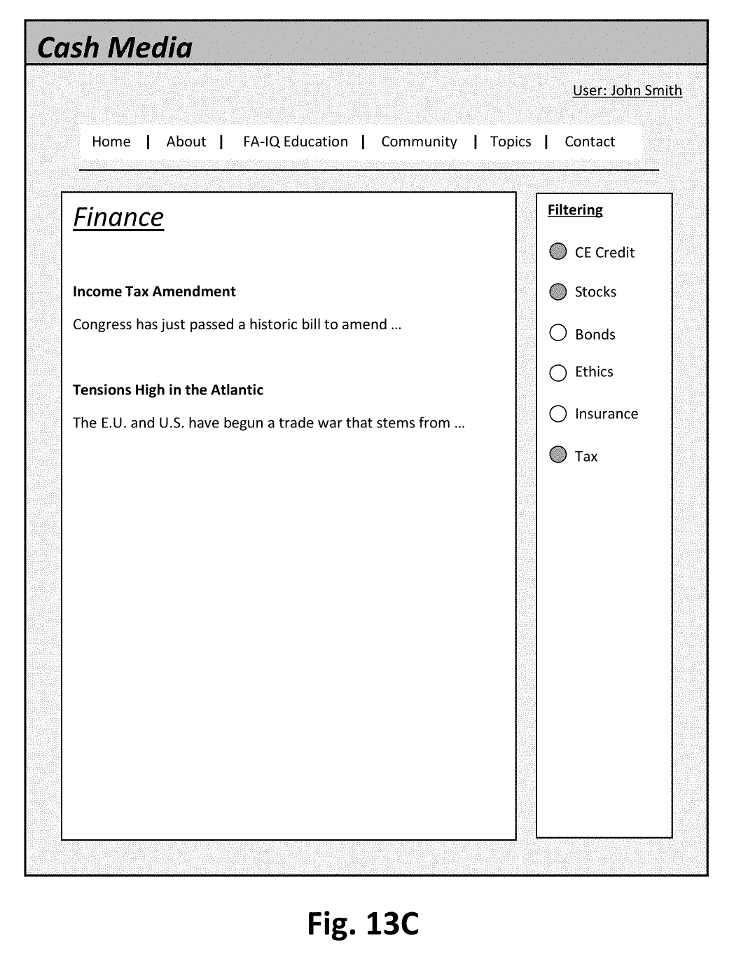

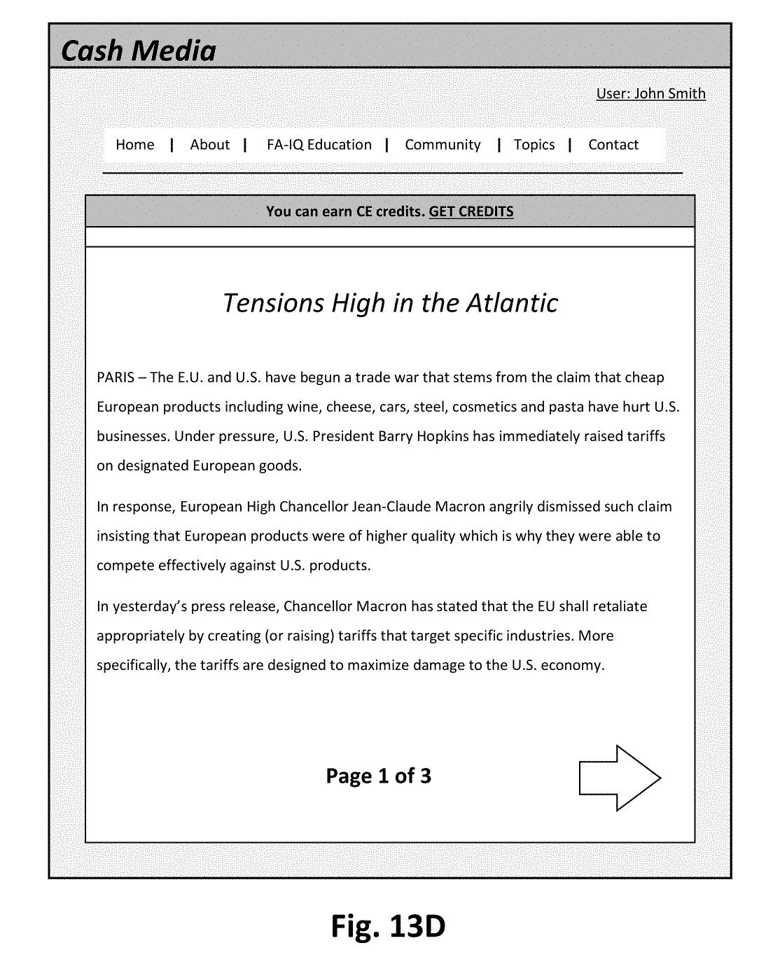

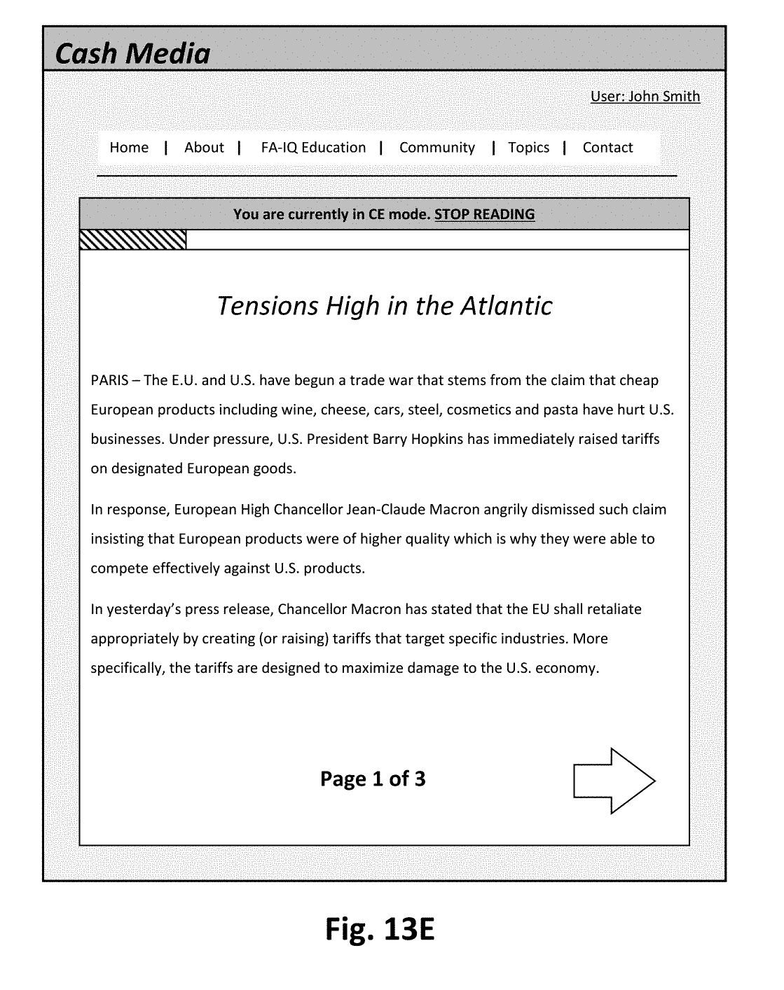

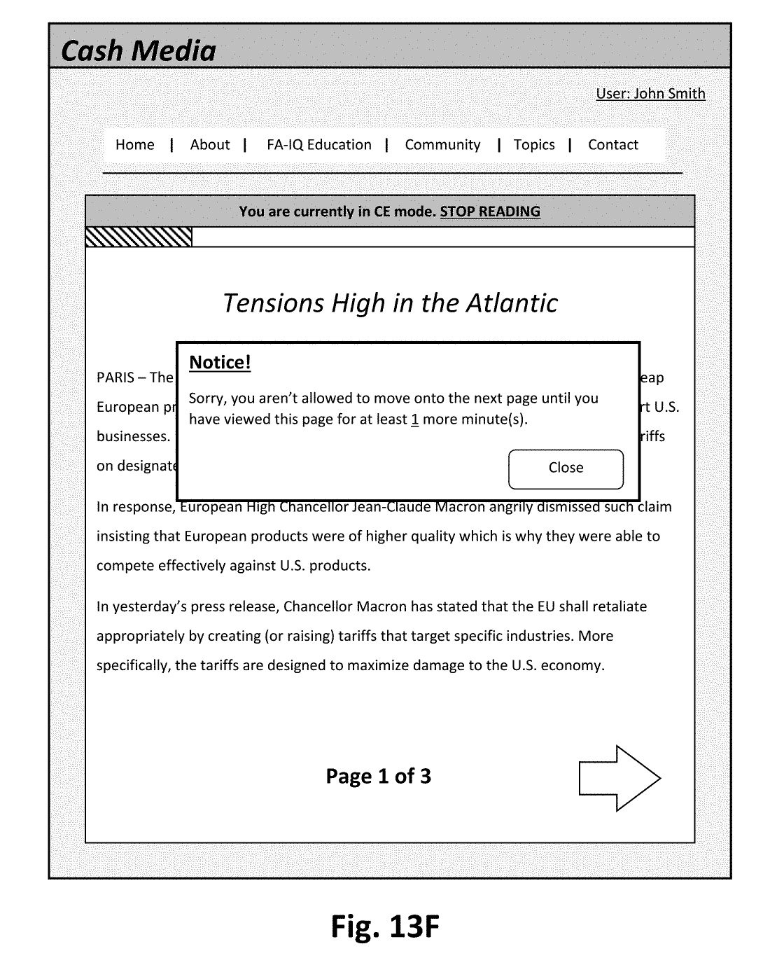

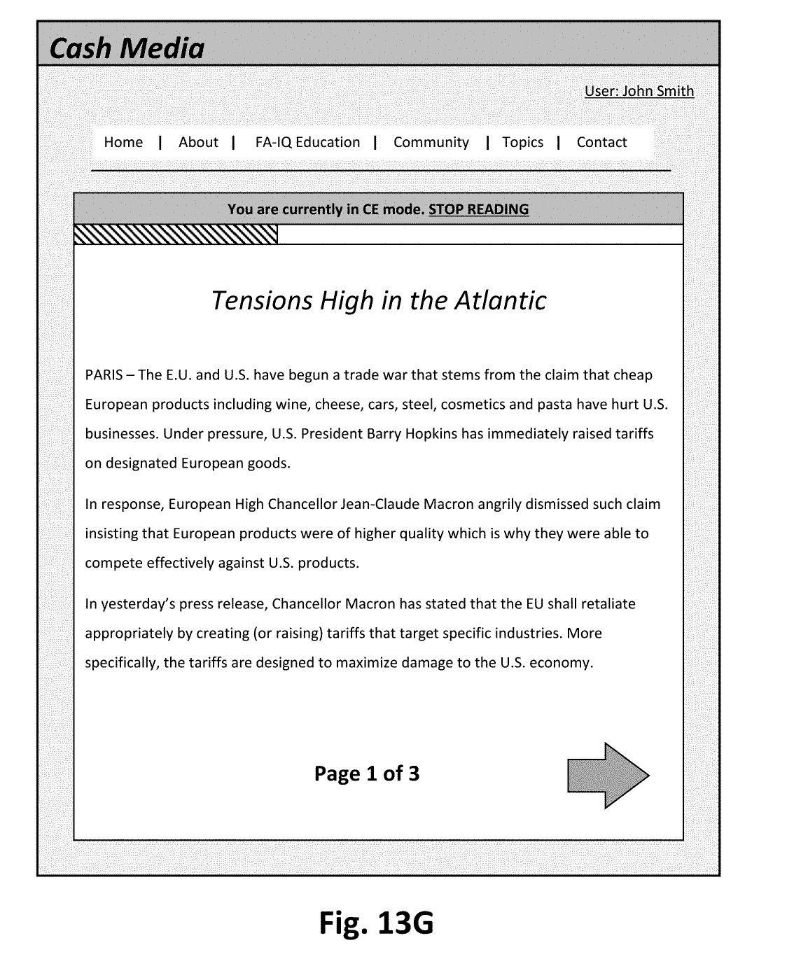

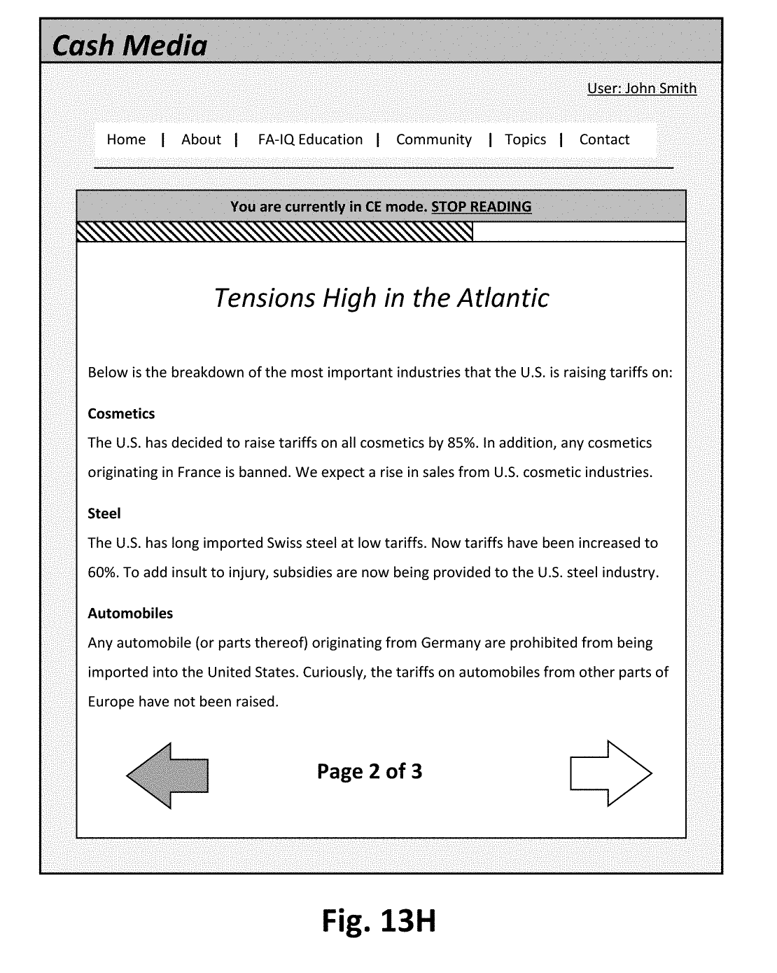

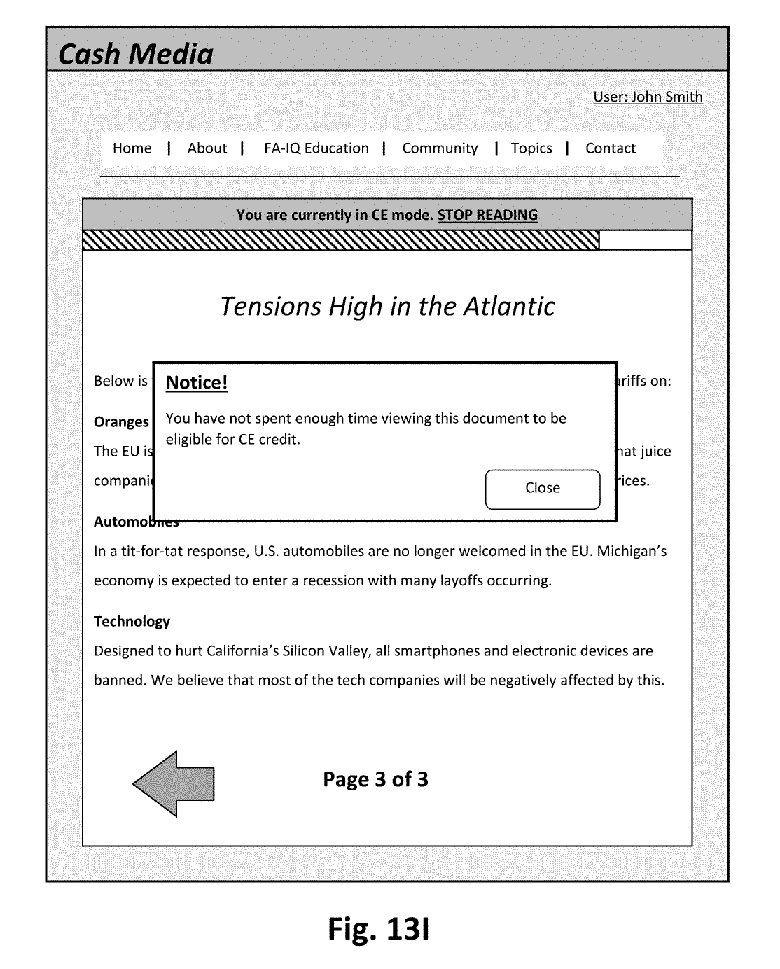

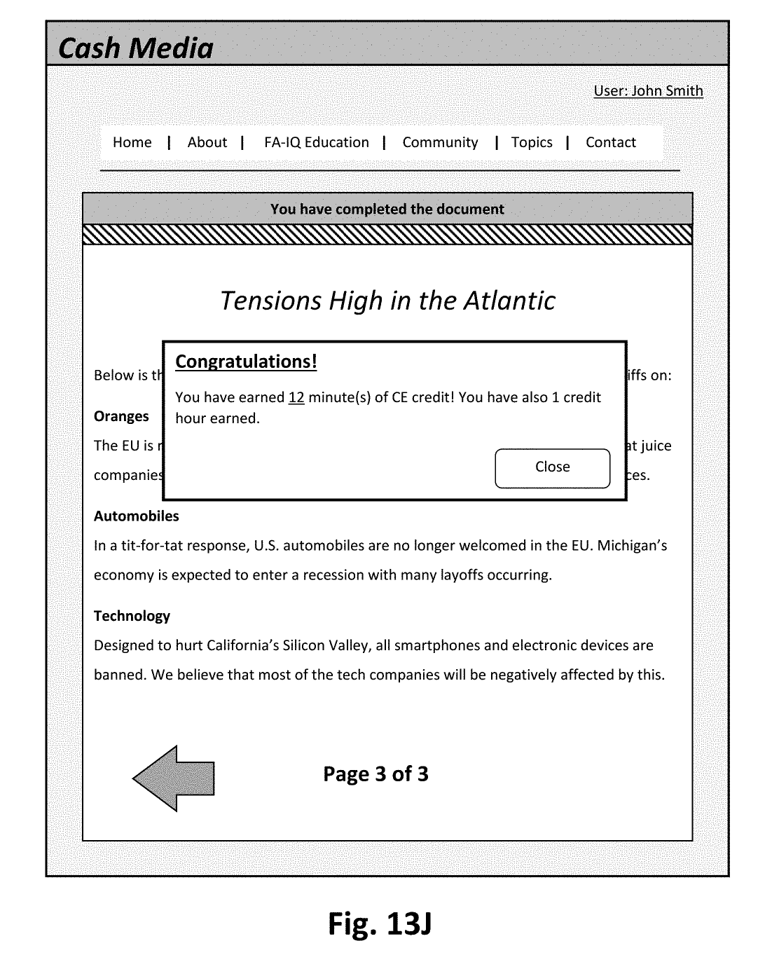

FIGS. 12A and 12B show an event process or workflow performed by a viewing verification application (e.g., 101a), according to an embodiment for providing a document to a user for earning CE credit. FIGS. 13A-J show screens presented to a user in connection with that work flow according to a scenario.

In one embodiment, the viewing verification apparatus recognizes that the user is eligible to seek and earn CE credit. For example, the user has registered for CE credit according to the work flow described with respect to FIG. 7. According to another embodiment, the system identifies the user as a new user that has not yet registered to receive CE credit. Such a new user is presented with a dialog box as shown in FIG. 13A and asked to provide authorizing information. For the present example, it is assumed that the user has registered for CE credit.

In another embodiment, the user may be presented with a filter to narrow the list of documents available for viewing based on one or more criteria as shown in FIG. 13B. For example, in this scenario, the user elects to narrow the list of documents to include only documents for which CE credit is available, and which contain subject matter on the topics of tax or stocks, as shown in FIG. 13C.

The user selects a document to view for CE credit from a list such as the one as shown in FIG. 13B or FIG. 13C and the viewing verification application 101a opens the selected document at step 1200. Next, the viewing verification application 101a displays a first page to the user at step 1202. In this case, the user has selected to view the article “Tensions High in the Atlantic” from a list of documents as shown in FIG. 13B or FIG. 13C, and is presented with the first page of the article that includes a banner (“You can earn CE credits”) as shown in FIG. 13D. By clicking on a “Get Credits” button, the system activates a “CE mode” function for verifying that the user has viewed the document, as will be described below. The user may select to turn off this feature. As shown in FIG. 13E, the user may turn off CE mode by clicking the “Stop Reading” button. Also, an indicator such as a progress bar is displayed near the top of FIG. 13E which shows the amount of additional viewing time required before the user is eligible to receive education credits. The progress bar fills (represented in this case by a bar having a series of diagonal lines) as time passes. According to another embodiment, instead of indicating the amount of time the user needs to spend to receive CE credit, the progress bar indicates the number of pages of the document the user has successfully viewed for CE credit. For example, for a 5-page document, when the user has viewed the first page for a sufficient time to receive CE credit, the progress bar would indicate that the user is 20% complete. After completing each successive page, the progress bar would advance another 20%, reaching 100% when the fifth and final page has been viewed for a sufficient amount of time.

After displaying the first page, the viewing verification application 101a activates a document timer at step 1204 for calculating the user's document reading time (i.e. the amount of time the user has spent in reading the entire document). Next, the viewing verification application 101a activates a new page timer at step 1206. Each time the user moves to a new page, a new page timer starts. This enables the calculation of the page viewing time (i.e. the amount of time the user has spent in viewing an entire page) for each page of the document.

After the user has started reading the first page, the viewing verification application 101a may determine at step 1208 whether the page timer has reached the predetermined page viewing period. In the case that the page timer has not reached the page viewing period at step 1208 (no), the viewing verification application 101a prevents the user from viewing the next page. The viewing verification application may display an indication, for example, in the form of a white (or alternatively greyed-out) arrow button (shown toward the right side) to communicate that the user cannot yet view the next page. In another example, if the user clicks on the right arrow button before the page timer has reached the page viewing period (so the user cannot view the next page), the viewing verification application 101a presents a message, such as shown in FIG. 13F, stating that the user cannot view the next page and presenting the time remaining in the page viewing period which must elapse before the user is eligible to view the next page. According to some embodiments, the user is required to view a page for only a predetermined portion of the page viewing period, for example, 50%, before being allowed to move on to a next page.

In the case that the page timer has reached the page viewing period (or the allowed portion thereof) at step 1208 (yes), the viewing verification application 101a determines if there are more pages to view in the document at step 1210. In the case that the viewing verification application 101a determines at step 1210 (yes) that there are more pages in the document, the viewing verification application permits the user to view the next page at step 1212. In one embodiment, in the case that the page timer has reached the page viewing period, the arrow button changes color (e.g., dark grey or black) to indicate that it can be activated to allow the user to view the next page as shown in FIG. 13G.

Next, the viewing verification application may determine at step 1214 whether the user has selected to view the next page. Even if the user is eligible to view the next page, the user may spend more time on a current page. In the case that the user has not selected at step 1214 (no) to view the next page, the viewing verification application 101a determines that the user selects to remain on the current page. The page timer for the current page will continue to accumulate time for that page until a next page is selected. In the case that the user selects at step 1214 (yes) to move on to the next page, the viewing verification application 101a stores a page reading time (i.e. total time the user spent in viewing the entire page) corresponding to the current page at step 1216. Next, the viewing verification application 101a displays the next page to the user at step 1218, a new page timer is started at step 1206, and the process repeats in a manner similar to the first page.

According to one embodiment, the user may to move back to view any page that he or she has already viewed. As shown in FIG. 13H, the user may view the previous page (as indicated by the grey arrow button) but may not view the next page (as indicated by white arrow button). According to another embodiment, if the user selects to view a previous page, the viewing verification application 101a stores a page reading time for the current page, and restarts the page timer for that previous page, allowing the user to accumulate additional page viewing time for the previous page. For example, in the scenario discussed above with respect to FIG. 2, user 1, who was allowed to view each of the pages of the document at a first point in time, but did not accumulate sufficient time to receive credit for the entire document, was able to return to previously viewed pages at a subsequent point in time to accumulate the additional time required to receive CE credit.

In the case that the viewing verification application 101a determines at step 1210 that there are no more pages in the document left to view, the viewing verification application 101a stores a document reading time (i.e. total time the user spent in reading the entire document) calculated based on the document timer at step 1220 in FIG. 12B. Next, the viewing verification application 101a determines at step 1222 whether the document reading time is greater than or equal to the document viewing period. If the viewing verification application 101a determines at step 1222 (no) that the document reading time is not greater than or equal to the document viewing period, the viewing verification application 101a displays a message to the user at step 1224 that he or she has not spent enough time reading the document to be eligible for CE credit as shown, for example, in FIG. 13I.

According to an alternative embodiment, instead of requiring the user to spend the full document viewing period on a single document in order to receive CE credit, the viewing verification apparatus determines whether a user has viewed the document for a minimum time increment, for example, six minutes. Once the user has reached the minimum time increment, the user is awarded CE credit for that time increment. As the user continues to view the document, the user accumulates CE credits each time a new minimum time increment is reach until the user has accumulated CE credits that total the document viewing period, which is the maximum CE credit a user can receive for viewing the document. According to this embodiment, the user can earn CE credit by partially reading numerous documents.

If the viewing verification application 101a determines at step 1222 (yes) that the document reading time is greater than or equal to the document viewing period, the viewing verification application 101a registers that the user has accumulated enough time to be eligible for CE credit equal to the document viewing period at step 1226. Then the viewing verification application 101a displays a message to the user at step 1228 indicating that the user has qualified to earn CE credit as shown, for example, in FIG. 13J. Note that, according to some embodiments, a portion of the document viewing period, for example, 83%, is sufficient for the user to earn credit for viewing a document. In the case where a user is entitled to credit based on a portion of the document viewing period, the amount of CE credit will be equal to the actual viewing time.

Where a user has earned CE credit for viewing a document accredited by one organization, for example, the CFP Board, and the user later registers to earn CE credit via the viewing verification apparatus for another accrediting organization, for example, CIMA, then the user will be given CE credit for the newly designated organization, provided the document contains content approved for CE credit for both organizations. In addition, where a document is accredited for CE credit by one organization, for example, CIMA and that document is later accredited by another organization, for example, the CFP Board then a user that has earned CE credits for the first organization by viewing the document will also receive CE credits with the second organization, provided the user is authorized to receive CE credits by both organizations. Thus, users authorized to receive CE credits for multiple organizations will only need to read a document once in order to earn credit for each of those organizations.

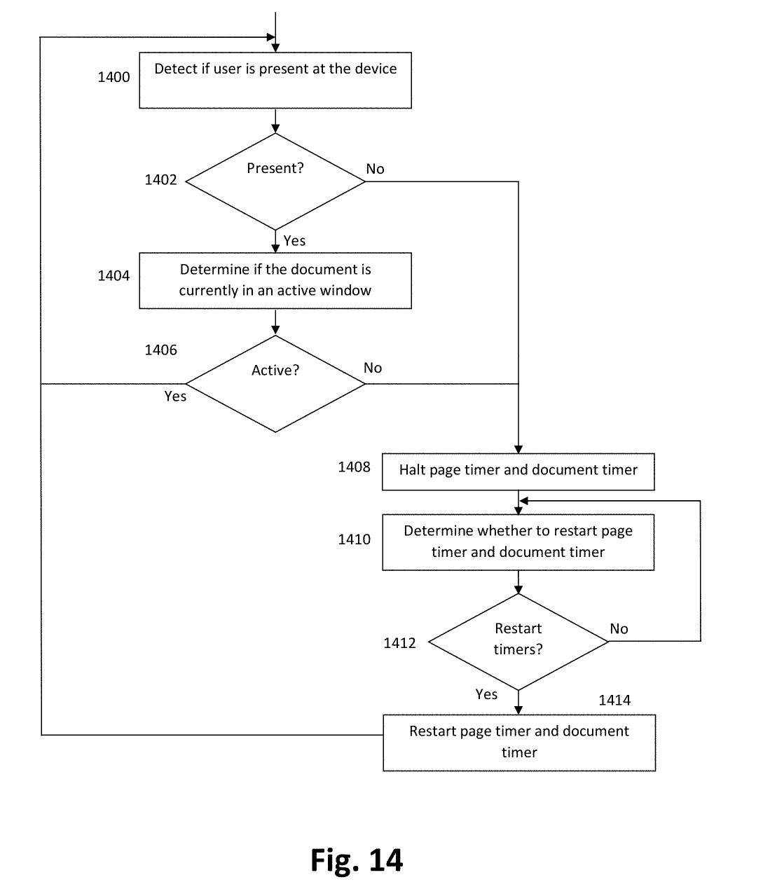

FIG. 14 shows an event process or workflow performed by a viewing verification application (e.g., 101a), according to an embodiment for detecting whether a user is viewing the content by the detection module 101a-5.

As discussed with respect to FIGS. 12A-B, the viewing verification application monitors the amount of time a user spends viewing each page of a document for which the viewer seeks CE credit, as well as the amount of time the user spends viewing the entire document. The detection module 101a-5 detects signals which indicate whether the user is actively viewing the document, or if the view is idle or performing other tasks. For the time period when the viewer is not engaged in viewing the document, the detection module 101a-5 pauses both the page and document timers until signals are detected which indicate that the user has resumed viewing the document.

According to one embodiment, at step 1400 the detection module 101a-5 detects signals which indicate whether the user is currently positioned or located at or near the device (e.g., terminal apparatus 103) while a page of a document is displayed for viewing and for earning CE credit. According to another embodiment, the detection module 101a-5 monitors whether signals indicative of active user behavior are received, such as for example from an input device (e.g., keyboard, touchpad, computer mouse), or other source. If no signal is received for a predetermined period of time (e.g., 30 seconds), the absence of such input is interpreted as indicating that the user is not currently viewing the document. According to yet another embodiment, the detection module 101a-5 communicates with camera 408 associated with the terminal apparatus 103 or the like to receive a signal which indicates whether the user is positioned or located at or near the front of the terminal. If the image captured by the camera indicates that the user is effectively absent, this is interpreted to mean that the user is not viewing the document.

If detection module 101a-5 detects that the user is effectively present at step 1402 (yes), it then determines at step 1404 whether the document is being presented to the user in an active window on the terminal apparatus 103. If the document is presented in an active window, this is interpreted as meaning the user is viewing the content. The process loops through steps 1400-1406 and if no signal indicating active user behavior, or no signal indicating that the user is positioned or located at or near the front of the terminal 103, is received for a predetermined period of time, then at step 1408, the detection module 101a-5 sends a signal to the timer generating module 101a-2 to pause the page timer and document timer.

Next, the detection module 101a-5 determines whether and when to restart the document timer and the page timer at step 1410. If at step 1612 (yes) an input signal is detected to indicate that the user is again effectively present and the document is in an active window, the detection module 101a-5 instructs the timer generating module 101a-2 to reactivate the timers and resume measuring the page viewing and document viewing times at step 1414. Otherwise, if the viewing verification application 101a still determines through the absence of input signals at step 1412 (no) that the user is not viewing the content, the viewing verification application 101a continues to pause the document timer and the page timer.

The aforementioned specific embodiments are illustrative, and many variations can be introduced on these embodiments without departing from the spirit of the disclosure or from the scope of the appended claims. In addition, elements and/or features of different examples and illustrative embodiments may be combined with each other and/or substituted for each other within the scope of this disclosure and appended claims.

For example, the orders in which the steps are performed in the aforementioned methods are not limited to those shown in the examples of FIGS. 5, 7, 9, 11, 12A, 12B and 14, and may be changed as long as similar results are achieved. Also, the methods illustrated in the examples of FIGS. 5, 7, 9, 11, 12A, 12B and 14 may be implemented using any of the systems described in connection with FIGS. 1A-1D.

1. A viewing verification application including one or more programs of instructions embodied in a non-transitory computer readable medium and executable by a computer to configure the computer to comprise:
a content display module to display a document selected by a user, the document comprising a plurality of pages; and
a timer generating module to generate a document viewing period and a plurality of page viewing periods corresponding to respective ones of the plurality of pages and for generating a document viewing timer and a plurality of page viewing timers for respective ones of the pages,
wherein the content display module displays a first page of the plurality of pages to the user and starts a first timer, and wherein the content display module allows the user to view a subsequent page after the first timer measures a time greater than or equal to the page viewing period corresponding to the first page.

2. The application of claim 1, wherein one or more subsequent viewing timers are started when the user selects to view one or more respective subsequent pages of the plurality of pages, wherein the user is allowed to view such subsequent pages when the viewing timer of a previous page measure times greater than or equal to the viewing period corresponding to a previous page, and further comprising:
a credit approval module for generating an education credit in a case that the user has viewed each of the plurality of pages and a total document viewing time is greater than or equal to the document viewing period.

3. The application of claim 1, further comprising a content publishing module that receives the document and converts the document to a predetermined file format.

4. The application of claim 1, wherein the document viewing period is generated based on a word count of the document.

5. The application of claim 1, wherein the plurality of page viewing periods are generated based on a word count of the respective pages.

6. The application of claim 1, wherein the document includes one or more non-text portions, and wherein the document viewing period and/or one or more of the page viewing periods are generated based on a length of time to present such non-text portions.

7. The application of claim 6, wherein the non-text portion is a video clip.

8. A method for confirming that a user is entitled to an education credit comprising the steps of:
receiving an authenticated content document, the document comprising a plurality of pages;
establishing for the document a required document viewing period;
establishing a plurality of required page viewing periods for respective ones of the plurality of pages;
transmitting the authenticated content document to a user via a computer network;
receiving user viewing data, the viewing data indicating operations conducted by the user in regard to the authenticated content document;
monitoring viewing activity of the user, the step of monitoring comprising;
a) detecting, from the viewing data, that the user has opened the document for viewing;
b) starting a document timer for recording a document viewing time;
c) detecting, from the viewing data, that the user has opened for viewing a first one of the plurality of pages of the document;
d) starting a first page timer to record a viewing time for the first page;
e) detecting, from the viewing data and the first page timer, that the user has viewed the first page for the required page viewing period for the first page;
f) detecting, from the viewing data, that the user has opened a next page of the plurality of pages of the document for viewing;
g) starting a next page timer to record a viewing time for the next page;
h) detecting, from the viewing data and the next page timer, that the user has viewed the next page for the required page viewing time for the next page;
i) repeating steps f) through h) until all of the plurality of pages have been opened for viewing; and
j) determining, based on the document timer and the viewing data, that document viewing time is greater than or equal to the required document viewing period; and
recording an indicia that the user has received the education credit.

9. The method of claim 7, wherein the required document viewing period or the required page viewing periods are established based on a word count.

10. The method of claim 8, wherein the required document viewing period or the required page viewing periods are established based on a word count at an assumed reading pace.

11. The method of claim 10, where the assume reading pace is 150 words per minute.

12. The method of claim 8, further comprising establishing a maximum credit period for the document, wherein the step of recording further comprises recording as part of the indicia the document viewing time or the maximum credit period, whichever is lesser.

13. A system comprising:
one or more terminals; and
a viewing authentication apparatus including one or more programs of instructions embodied in a non-transitory computer readable medium and executable by a computer to configure the computer to comprise:
a content display module to transmit for display a document selected by a user of the one or more terminals, the document comprising a plurality of pages; and
a timer generating module to generate a plurality of page viewing periods that correspond to respective pages of the document, the timer generating module initiating a page viewing timer for each page of the document that is currently being viewed, wherein the user is allowed to view a subsequent page after the page viewing timer for a current page measures a time greater than or equal to the page viewing period of the current page.

14. The system of claim 13, wherein the timer generating module generates a document viewing period, and initiates, when a first page of the document is displayed to the user, a document viewing timer that monitors a total document viewing time.

15. The system of claim 14, wherein the viewing authentication apparatus further comprises a credit approval module for generating an education credit in a case that the user has viewed each page of the document and that the total document viewing time is greater than or equal to the document viewing period.

16. The system of claim 15, further comprising:
a certification management apparatus to record education credits accumulated by the user, wherein when the credit approval module generates the education credit for the user, the generated education credit is transmitted to the certification management apparatus.

17. The system of claim 13, wherein the viewing authentication apparatus monitors statistical data on documents accessed by users of the one or more terminals.

18. The system of claim 17, further comprising:
a metrics management apparatus to receive the statistical data at regular intervals from the viewing authentication apparatus, and to transmit the received statistical data to a document publisher.

19. The system of claim 13, wherein the viewing authentication apparatus further comprises a content publishing module that receives the document and converts the document into a predetermined file format.

20. The system of claim 19, wherein the viewing authentication apparatus stores the converted document into a content database that is connected to the viewing authentication apparatus.
